(19) United States
(12) Patent Application Publication
(10) Pub. No.: US 2025/0164433 A1
(43) Pub. Date: May 22, 2025

(54) SYSTEMS AND METHODS FOR POINT-OF-NEED SENSING USING AN ELECTROCHEMICAL SENSOR

(71) Applicant: E-Sentience, Inc., Newark, NJ (US)

(72) Inventors: Julio Fredin Ortiz, Indianapolis, IN (US); Meredit Qi Lee, Sewell, NJ (US)

(21) Appl. No.: 18/950,853

(22) Filed: Nov. 18, 2024

Related U.S. Application Data
(60) Provisional application No. 63/600,035, filed on Nov. 17, 2023.

(51) Int. Cl. G01N 27/327

(52) U.S. Cl. CPC G01N 27/3277; G01N 27/3278

(57) ABSTRACT

Systems and methods for measuring an analyte comprising: a working electrode comprising: a sensing structure with a conductive layer deposited on a substrate and a molecular imprinted polymer (MIP) layer deposited on the conductive layer, and a membrane structure on the sensing structure. Wherein the working electrode may include a membrane structure that is multilayered membrane structure, a redox mediator integrated into the membrane structure, and/or a plurality of redox mediator materials.

### CROSS-REFERENCE TO RELATED APPLICATIONS

This Application claims the benefit of U.S. Provisional Application No. 63,600,035 filed on 17 Nov. 2023, which is incorporated in its entirety by this reference.

### TECHNICAL FIELD

This invention relates generally to the field of chemical and electrochemical sensors and more specifically to a new and useful system and method for point of need sensing using an electrochemical sensor.

### BACKGROUND OF THE INVENTION

The field of chemical monitoring plays a critical role in various applications such as performance monitoring, assessing health status, and assessing chemical threats. However, there are several issues and challenges associated with the current state of this technology field.

One common issue is that many traditional monitoring approaches tend to be slow and expensive. They often involve time-consuming analytical procedures, expensive laboratory equipment, and the need for highly trained personnel. As a result, the cost and complexity of these approaches can limit their accessibility and usefulness for routine and real-time monitoring.

Another limitation is that these monitoring processes typically require a sample to be transferred to a testing facility. For biomarkers, this usually involves an individual going to a testing or collection site in person to provide a sample for analysis. For analysis of chemical threat detection of house water supplies, a sample must be collected and then sent off for processing. These inconveniences can result in reduced compliance, delays in obtaining results, and limited applicability for situations where continuous or point-of-need monitoring would be preferable.

Thus, there is a need to create a new and useful system and method for an enhanced chemical sensor. This invention provides a new and useful system for point-of-need sensing using an electrochemical sensor.

### BRIEF DESCRIPTION OF DRAWINGS

FIG. 1 shows a schematic representation of a system using a membrane stacking variation.

FIG. 2 shows a schematic representation of a system variation with a redox mediator infused in a gel.

FIG. 3 shows a schematic representation of a system using multiple redox mediators for enhancing detectable signals in comparison to a system using a single redox mediator.

FIG. 4 shows a schematic representation of a system variation using

multiple redox mediators within a solid-state MIP sensor.

FIG. 5 shows a schematic representation of a system variation using membrane stacking in combination with multiple redox mediators infused in a gel.

FIG. 6 is a schematic representation of one system variation of an enhanced electrode.

FIG. 7 is a schematic representation of a sensing electrode system.

FIG. 8 is a schematic representation of a sensor device.

FIG. 9 is a schematic representation of another system variation of an enhanced electrode.

FIG. 10 is a schematic representation of a variation of an enhanced electrode.

FIG. 11A is a schematic representation of impact of an analyte on electrical pathways through the molecular imprinted polymer layer where electrons make substantially random pathways through the layer.

FIG. 11B is a schematic representation of impact of analyte on electrical pathways through the molecular imprinted polymer layer where added nanoparticles establish low energy pathways.

FIG. 12 is a graph of an exemplary voltammetry response.

FIGS. 13 and 14 are schematic representations of optical sensing system variations.

FIG. 15 is a representative chart of different MXene material variations.

FIG. 16-23 are flowchart representation of method variations for production and operation of a working electrode and/or sensor.

### DETAILED DESCRIPTION OF THE EMBODIMENTS

The following description of the embodiments of the invention is not intended to limit the invention to these embodiments but rather to enable a person skilled in the art to make and use this invention.

### 1. Overview

The systems and methods described herein present enhancements to electrochemical sensors. In particular, the systems and methods may provide electrochemical sensor designs that can enhance and improve sensing capabilities over the existing field.

The systems and methods may utilize an enhanced working electrode that can react to and measure one or more types of target molecules (i.e., an analyte or analytes) as a result of an imprinting process. More specifically, the systems and methods preferably enable an electrochemical sensor that uses an enhanced working electrode that is a 2D printed sensing stack with a molecular impression polymer (MIP) layer that is imprinted to specifically target a variety of molecules.

The systems and methods operate based in part on nano-scale cavities within the enhanced electrode that can selectively bind with target molecules when the molecule is present in a sample, and thereby causing changes in the electrochemical properties of the electrode. The systems and methods may alternatively be used with other types of electrochemical sensors.

The systems and methods can include a guard membrane structure/layer and a conductive layer on opposite sides of the MIP layer. The guard layer can facilitate filtering and manage collection, concentrating, filtering, and/or otherwise preparing for sensing, while using a membrane structure to reduce contamination and particle noise for increased selectivity of molecules in the MIP layer. The conductive layer can facilitate electrochemical sensing of an analyte captured in the MIP layer.

Variations of the system and method may use a guard membrane structure that is a multilayered membrane structure (e.g., multilayer gel, cellulose, glass microfiber, polymeric films, and the like), redox mediators infused within the membrane structure, and/or multiple redox mediators. These systems and methods and their variations described herein may be used to enable better electrochemical sensors that can be used for detection and measurement of select analytes through wicking, solution retainment, and filtering

The systems and methods may in particular be used with nanostructure-based sensors, such as MXene-based sensors that use nanostructure or MXene-based conductive layers, which function to detect and/or measure levels of one or more types of molecules.

The systems and methods may utilize 2D printing technology enabling a more portable and mobile sensing platform. The enhanced electrode may be imprinted and customized for a variety of different targeted analytes. In particular, the enhanced electrode may target measuring of hormones, electrolytes, inflammatory markers, and/or other targeted analytes.

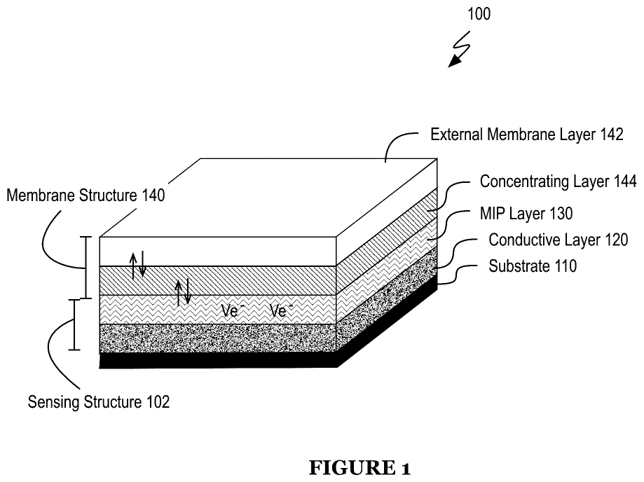

As one variation shown in FIG. 1, the systems and methods may employ a multilayered membrane structure as a guard layer as an approach for collecting and concentrating different analytes near an electrode sensing region. A membrane structure as a guard layer may use two or more different layers that use various materials (e.g., biocompatible materials). These different layers may, in some variations, be soaked with different solvent matrices to concentrate analytes at an inner layer near the electrode of a sensor based on solubility of the analyte. For example, a hydrogel layer may be used as an external facing layer where a sample is exposed or contacted. Beneath the hydrogel layer may be an alcogel layer with different analyte solubility. In this example, an analyte like cortisol which has higher solubility in alcohols like ethanol, will diffuse through the hydrogel and then diffuse and stay within the alcogel.

In some variations, each membrane layer of a multilayered membrane structure may also hold a particular function with an aim to eliminate/mitigate interference or otherwise enhanced sensing. For example, a multilayered membrane structure may contain a dry hydrogel to enhance wicking samples, which can be filtered through a glass microfiber pad, and then filtered through a cellulose pad impregnated with redox mediator components (i.e., redox probes), allowing for a refined sample that prevents biological fouling of the sensitive electrode surface.

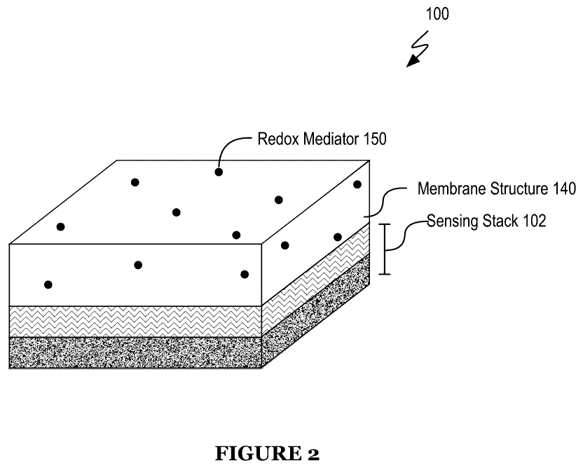

As another variation shown in FIG. 2, the systems and methods may use an approach where a membrane structure (or at least a layer of the membrane structure) is saturated or at least partially infused with a redox mediator. This may avoid embedding a redox mediator into a MIP layer of an electrochemical sensor, which may enhance sensing capabilities in some applications.

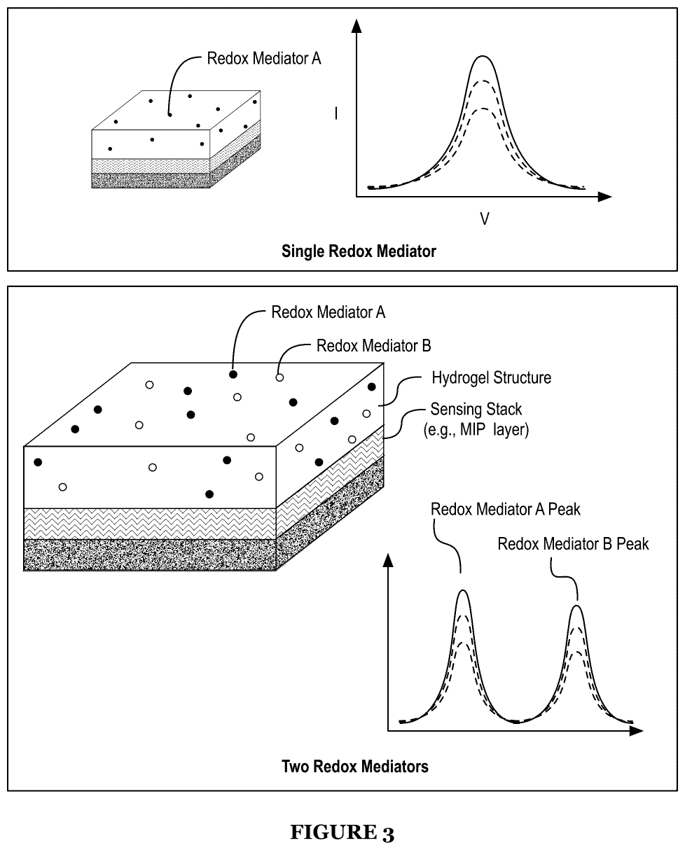

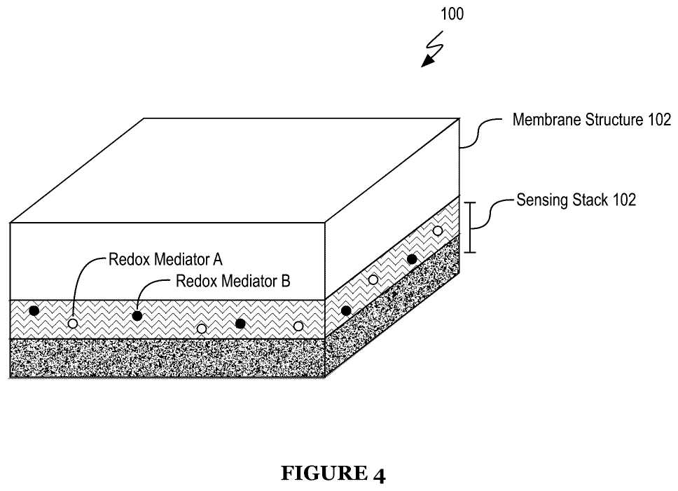

As another variation shown in FIG. 3 and FIG. 4, the systems and methods may use multiple redox mediators with different response profiles. By using multiple redox mediators, the sensor may be capable to capture multiple, independent measurements for each redox mediator within their response curves peak, allowing for integration of the data to have self-corrective statistics.

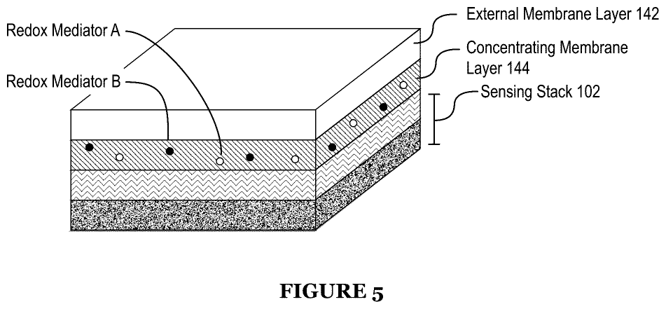

These variations may be used independently within an electrochemical sensor but may alternatively be used in combination. Different variations may employ these system and method variations in various permutations. For example, as shown in FIG. 5, a version may use multi-layer membrane stacking, infusing a redox mediator within a membrane layer, and using multiple redox mediators for improved measurements.

The systems and methods may be used as part of an enhanced electrode, an improved electrode sensing system, or a sensing device. In particular, the sensing systems and methods may be a nanostructure-based sensor (e.g., 2D nanomaterials or complex geometries) or electrochemical sensor. Some variations may use a MXene conductive layer to make a MXene-based sensor that incorporates one or more features of the system and method.

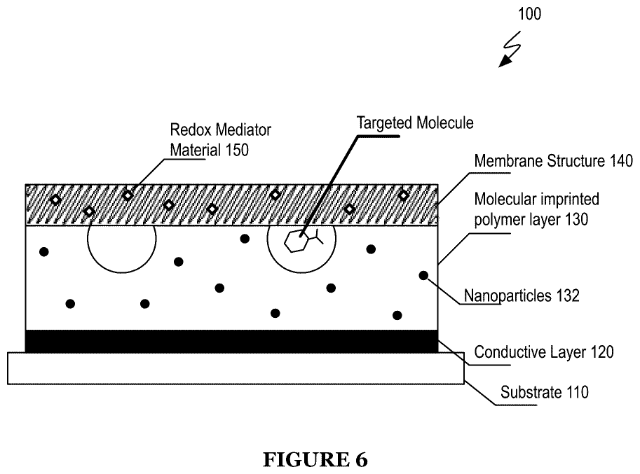

In an enhanced sensing electrode variation of the systems and methods, the sensing electrode may include multiple layers or structures, which may include a membrane structure and a sensing structure with a molecular imprinted polymer (MIP) layer and a conductive layer as shown in FIG. 6. The conductive layer may be a specialized nanostructured sensing layer. These layers collectively function as a filter, redox probe storage, a sensing element, and a highly conductive electrode element, enabling precise, near real-time and accurate molecule detection. In

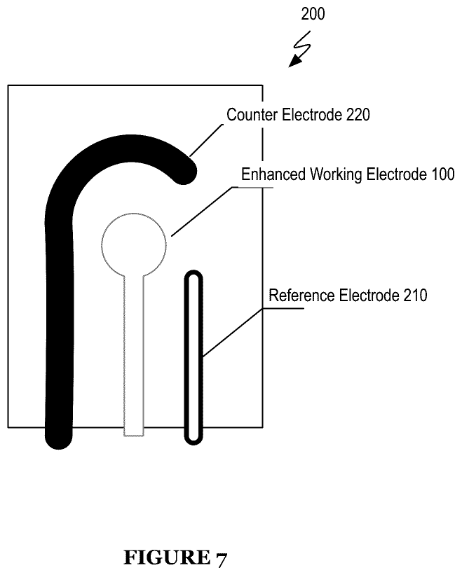

In some embodiments, the enhanced electrode can be integrated into a sensing electrode system, which may include the enhanced working electrode and a reference electrode and a counter electrode, as shown in FIG. 7. This configuration allows for additional calibration and reference signals, resulting in improved interpretation of measurements obtained from the enhanced electrode.

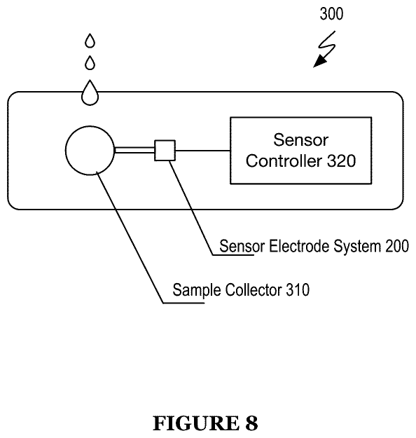

Furthermore, the systems and methods may additionally be applied as part of a sensor system or device, where one or more sensing electrode systems are integrated with a sample collector and sensor controller, creating a versatile sensor device. Such a device can be designed with various form factors to cater to different application requirements. In such variations, the systems and methods may be used within a sensing device 300 that includes a sensing electrode system 200, a sample collection and management system 310, and a sensor controller 320 as shown in FIG. 8.

This inventive system and method offer a significant advancement in the field of molecular detection by providing a highly sensitive and selective enhanced working electrode, capable of being utilized in diverse sensing electrode systems and sensor devices.

Embodiments including a sensing electrode system may utilize 2D fabrication design such that the sensing electrode may be printed or otherwise produced through stacked layering of electrochemical components. In this way, the systems and methods described herein may be used in making small form-factor sensing electrodes, which may be integrated into sensor devices. For example, the sensing electrode may be part of a sensing strip that can be affordably used and replaced. This may enable more regular testing, and easier testing, which may open up at-home and/or mobile testing of various analytes.

The systems and methods may be used in a variety of chemical sensing applications. Some exemplary forms of electrochemical sensing may include biosensor variations and/or environmental sensor variations of the systems and methods.

The systems and methods may be adapted or configured for monitoring a wide variety of different types of molecules. This may be particularly useful when used as part of a sensor, but this may be used in any suitable type of chemical/substance analysis monitoring use case such as biosensing and environmental sensing use cases.

In one use-case, the systems and methods may be used in connection with hormone measurement or monitoring. In one example, cortisol levels may be monitored using the systems and methods. In another example, PFAS (per-or poly-fluoroalkyled substances) and/or heavy metals and/or disinfection byproducts could be monitored in drinking water as a form of environmental sensing.

In another use-case, the systems and methods may be used in connection with disease biomarker detection such as tracking for one or more biomarkers associated with a disease or condition such as cancer, Alzheimer's, cardiovascular disorders, Diabetes, Kidney disease, liver disease, thyroid disorders, and the like.

In another use-case, the systems and methods may be used in connection with hydration and/or nutrition monitoring. The systems and methods may be used to measure electrolytes, ions, salts or lactate, a byproduct of glucose breakdown, and/or any other nutrition or hydration related markers.

As another related use-case, the systems and methods may be used in connection with monitoring metabolic markers such as, ketone bodies, urea, creatine, or creatinine. The system and method could similarly be used in monitoring chronic health conditions such as heart failure and/or chronic kidney disease.

In another use-case, the systems and methods may be used in connection with food safety testing, where food-borne pathogens or toxins can be monitored.

In one use-case, the systems and methods may be used in connection with environmental monitoring, wherein an enhanced electrode is configured for monitoring for specific molecules and/or analytes. For example an environmental sensor may have an enhanced electrode that is configured for detecting and/or monitoring PFAS (per- and poly-fluoroalkyled substances) and/or heavy metals and/or disinfection byproducts. In another variation, the systems and methods may be used for monitoring water contaminants in real time to ensure drinking water is up to regulatory standards right after measurement.

Herein, the systems and methods may reference biosensing and environmental sensing and applications of biosensing and environmental sensing, but the systems and methods are not limited to these examples and may be used or configured for measuring any suitable type of molecule for any suitable application. For example, the systems and methods may be used in other areas of applications such as for analyzing sewage, wastewater, food, drinks, personal care products, and/or any suitable type of material.

The system and method may provide a number of potential benefits. The system and method are not limited to always providing such benefits and are presented only as exemplary representations for how the system and method may be put to use. The list of benefits is not intended to be exhaustive, and other benefits may additionally or alternatively exist.

As one potential benefit, the system and method may improve analyte management within a membrane structure. This may be used to filter, direct, concentrate, and/or otherwise manage analyte molecules for improved sensing using an electrode, optical sensor, or any suitable sensing technique.

As another potential benefit, the system and method may result in a stronger and more accurate signal. This may be a related benefit to improved analyte management but may additionally or alternatively result from leveraging redox moderators to improve electrochemical signals.

As another potential benefit, the systems and methods may enable a more usable sensor device. In addition to improved accuracy mentioned above, the membrane structure may enable a more user-friendly form factor that can be used in situations such as when used with a biosensor to more easily collect samples such as sweat from the skin.

As another potential benefit, the systems and methods may be used in creating a chemical/electrochemical sensor that can provide a more mobile and portable testing solution. Similarly, the systems and methods may enable near real-time testing and monitoring.

As another potential benefit, the system and method may offer non-invasive or minimally invasive sample collection methods. By using a design enabling testing of biological fluids such as sweat or saliva, the systems and methods may enable more comfortable and user-friendly monitoring options, which could increase patient compliance and facilitate continuous tracking of health markers. For example, resilience of the enhanced working electrode against non-homogeneous samples, can make administration of testing more accessible to those not trained in sample handling. Accordingly, in some variations, subjects may self-administer testing by following simple instructions for supplying a sample to a sensor device. In some cases, this may include spitting onto a testing strip/component or even adhering or otherwise wearing a sensor device such that a sample can passively be collected by the sensor device (e.g., absorption of sweat).

As another potential benefit, the systems and methods may enable a sensing electrode that is more biocompatible with a user. For example, along with biocompatible polymers, cellulose, and glass microfibers, the biosensor could contain all liquid and solid components for sweat and saliva testing without the introduction of possible irritation when in contact with users when dried, allowing for electrode environment deviations to decrease.

As another potential benefit, the system and method may enable improved sensing performance in biosensors, resulting in greater accuracy and sensitivity. This enhanced capability allows for more reliable detection and measurement of targeted molecules, which can be crucial in various applications such as disease diagnosis or environmental monitoring. The system and method use a molecularly imprinted polymer (MIP) layer that can specifically target a variety of molecules, while using a membrane structure as a guard layer to reduce contamination and particle noise for increased selectivity of molecules in the MIP layer. Additionally, integration of nanoparticles may provide enhanced conductivity that functions to improve sensing limits of analyte detection.

As another potential benefit, the system and method may provide a flexible platform that can be adapted to a variety of use-cases, form factors, and applications. The systems and methods may be calibrated for targeting a variety of different types of molecules. This adaptability enables the development of customized solutions tailored to specific needs, whether it be in healthcare, environmental monitoring, food safety, or industrial processes.

As another potential benefit, the system and method may enable the development of cost-effective diagnostic or monitoring tools. The systems and methods may lend themselves to use of 2D printing, deposition techniques, and layer-based thin-film manufacturing techniques. This may make the enhanced working electrode and/or the sensing electrode system as a whole, easier to manufacture and with substantially low cost for each sensing electrode. Due to the adaptable nature of the platform and potential for simpler detection methods, these tools could be made more affordable, increasing access to vital diagnostics and monitoring capabilities for a wider range of users.

Furthermore, the system and method may allow for real-time or near-real-time analysis of biomarkers. Faster data acquisition and processing can lead to more timely decision-making and intervention, helping healthcare providers and individuals manage health conditions more effectively. A traditional chromatographic technique may require a sample to elute through a column for over an hour in addition to requiring time for sample preparation. The system and method may be sufficiently easier to administer and faster when processing a sample. As a faster, more mobile, and easier to use sensor solution, the systems and methods may provide point-of-need sensing.

### 2. System

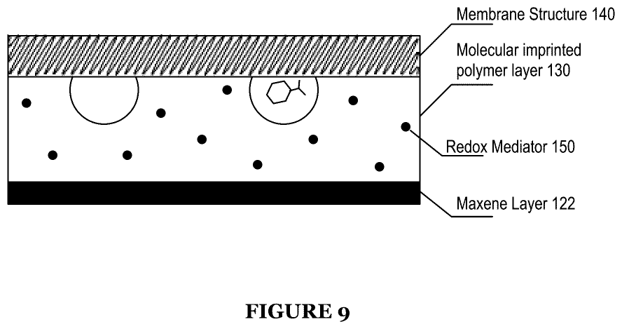

As shown in FIG. 9, a system for point-of-need sensing with an electrochemical sensor can include an enhanced, specially configured working electrode 100. The system may be used to process a sample to detect and quantify a specific analyte (i.e., target molecule) or a set of analytes. The enhanced electrode functions to provide variable electrical properties based on exposure to a sample and the amount of an analyte in the sample.

Herein, are presented variations including use of multilayered membrane structure, integration of redox mediators in the membrane structure, and/or use of multiple redox mediators to enhance. These variations are preferably applied to an electrochemical stack for a working electrode 100 described herein.

The working electrode 100 of the system is preferably prepared and configured for reacting to one or more types of target molecules. More specifically, the working electrode 100 is prepared through an imprinting process where targeted molecules are used to create nano-scale cavities defined in portions of the working electrode 100. When used, those cavities may be filled by the targeted molecules if the molecule is present and moves into the cavity. The number of cavities filled by molecules results in changing electrical properties of the working electrode 100. Configuration of the working electrode through use of a multilayered membrane layer 140 and manner of use of a redox mediator (layer integration and use of multiple redox mediator types) can alter and enhance sensing capabilities of the working electrode 100.

The working electrode 100 preferably includes a set of layers or structures that function as a filter, a sensing element, and a highly conductive electrode element. In particular, the working electrode 100 may include a sensing structure 102 that includes a conductive layer 120 deposited on a substrate 110 and a molecular imprinted polymer (MIP) layer 130 deposited on the conductive layer 120 and a membrane structure 140 on the sensing structure 102 (e.g., on the MIP layer 130). The membrane structure 140 may include a redox mediator material 150 integrated within the membrane structure 140 and/or the MIP layer 130. The MIP layer 130 is imprinted with template molecules defining cavities for a target molecule or molecules of an analyte of interest. In some variations, the MIP layer 130 may additionally include integrated nanoparticles 132 to further facilitate enhanced sensing capabilities of the working electrode 100 as shown in FIG. 6.

The membrane structure 140 in connection with the redox mediator material 150 functions to filter non-targeted particles and molecules while allowing targeted molecules of the analyte to transition or diffuse into the MIP layer 130. Within the MIP layer 130, the analyte will have individual molecule instances captured in the defined cavities of the MIP layer 130, which thereby alters electrical properties when driving the electrode via the conductive layer 120.

The substrate 110 functions as a non-conductive layer on which the electrode and/or electrode sensing system can be built. The substrate 110 is preferably a non-conductive material. In one variation, the substrate 110 may be a ceramic material, but any suitable non-conductive material may be used. However, there may be alternative variations where a conductive substrate is used. In such variations, the substrate region of an electrode is preferably conductively isolated from other electrodes and/or electrical components.

The substrate 110 may be a rigid or a flexible material. In some variations, the substrate 110 may be a substantially flat planar surface. However, the substrate 110 may alternatively have a non-flat surface geometry. The electrode and electrode system may use printing and/or deposition manufacturing techniques and as such the working electrode and more generally a sensing electrode system may be built up as layers on any arbitrary surface of a substrate 110. In some variations, the substrate 110 may be a structural component of some element which could have a form customized for the use case. As an example of the system's adaptability, an enhanced working electrode could be assembled on an inner or outer curved surface of a cylindrical tube-like structure.

The conductive layer 120 functions as a conductive part of the electrode stack serving as a receptacle for current in an enhanced electrode system. The conductive layer 120 is preferably a layer adjacent to and in conductive contact with the MIP layer 130. The conductive layer 120 will additionally be coupled to a controlling electrical system such that an external electrical system can control application of electric potential to the conductive layer 120.

The conductive layer 120 preferably enables an electrical current to be driven using the conductive layer 120 through the MIP layer 130 so as to measure the current/impedance and assess/quantify presence of an analyte. In addition to conductivity characteristics, the conductive layer 120 may additionally function as an EMI (electromagnetic interference) shield that can protect the 2nd stack from external noise.

The conductive layer 120 in one variation may be a nanostructured sensing layer that can be made of a variety of nanomaterials or nanostructured material options. In some variations, the nanostructured sensing layer is made of a MXene material and as such may be a MXene conductive layer 122. In some variations, the MXene layer may more particularly be a MXene carbon layer that is a mixture of carbon and MXene material. This may increase layer thickness and strength. The conductive layer 120 may alternatively be made of carbon black, graphene, gold, silver, and/or a combination of materials. In particular, the conductive layer 120 may be a conductive layer made from a conductive ink printed or otherwise deposited onto a surface of the substrate 110. In other words, the conductive layer may be a conductive ink printed onto the substrate. The conductive layer may be made of various conductive materials such as MXene material, a MXene carbon material, carbon black ink, graphene ink, silver ink, and/or gold ink. Accordingly, the conductive layer 120 may be selected from the group consisting of a MXene material, a MXene carbon material, carbon black ink, graphene ink, silver ink, and gold ink. A conductive ink may be printed using inkjet printing, screen/mask printing, and/or using another material deposition approach. The conductive layer 120 may use particular materials depending on priorities related to cost, conductivity, and/or chemical resilience.

The conductive layer 120 in particular may be an ink-jet printed layer using a conductive ink. An ink-jet printed layer may have a material form substantially different from a layer printed using screen printing. An ink-jet printed layer can have reduced pore/feature sizes compared to screenprinted ink layer. Additionally, the ink-jet printed layer may be made substantially thinner and have topographic features (such as pores and fractures) sizes substantially smaller compared to a screenprinted ink layer. An inkjet printed conductive layer in one variation may be approximately a micron thick (e.g., 1-10 micrometers) and have topographic features sized on the scale of 5-500 nm. For example, the conductive layer may be an inkjet printed conductive layer that is approximately 10 nm in thickness. However, in some variations, screen printing may be used as an alternative conductive layer 120. Accordingly, a variation may include a conductive screenprinted layer. A conductive screenprinted layer in some implementations may have layer thickness 10-100 micrometers and may have topographic feature sizes 2-10 micrometers.

In some variations, the conductive layer 120 may include layers of two or more different conductive materials. In one example, a MXene or MXene carbon layer may be directly printed on the substrate 110 and a gold or silver may be printed on top of the MXene or MXene carbon layer. In such a variation, the conductive layer 120 may include a MXene conductive layer adjacent to the substrate and a gold or silver conductive layer between the MXene conductive layer and the MIP 130 layer. As a similar variation, a MXene conductive layer 122 may include or integrate gold nanoparticles, silver nano rods, or other conductive nanoparticles, contributing to high conductivity.

In one preferred variation, there is a single conductive layer 120 that can be stimulated as a whole region for the working electrode. In some alternative variations, there may be distinct sub-regions with partitioned or isolated portions of the conductive layer 120. Accordingly, the conductive layer may include conductive sub-regions isolated to sub-sections of a working electrode. In this way, stimulation and sensing could be isolated to sub-regions of the adjacent MIP layer 130. If those sub-regions of the MIP layer 130 correspond to imprintation of different molecules, then different types of molecules could be measured within a shared electrode by switching between different conductive sub-regions.

Alternatively, when integrated into a sensing electrode system 200, multiple distinct working electrodes 100 may be included, which can be individually selected. More generally, if different analytes are to be tested then there may be multiple sensing electrode systems 200.

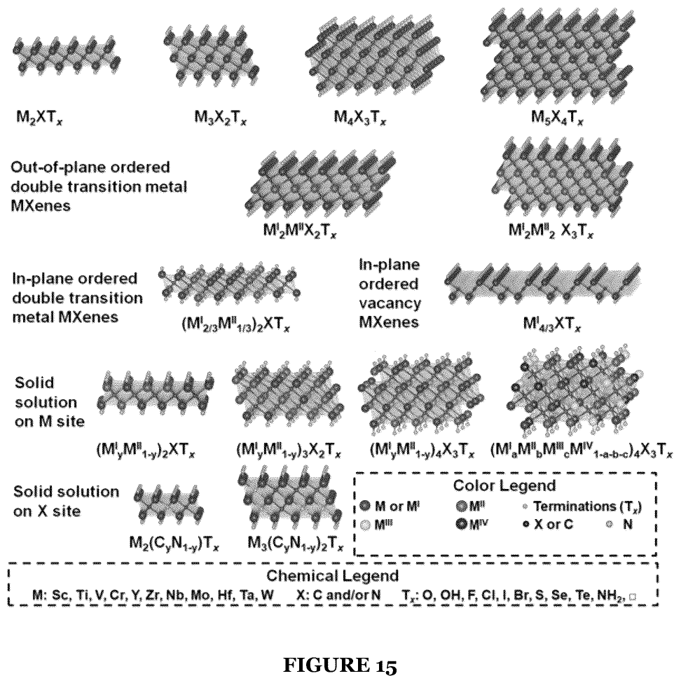

A MXene conductive layer 122 can be made of a variety of MXene material options. A MXene material is preferably characterized as a nanostructured, layered, metal carbide or nitride material of a few atoms in thickness with a formula of Mn+1Xn Tx. This MXene material may be produced by etching an “A” layer from a Mn+1AXn, performing sonication to yield a resulting MXene. This may include producing M2X from M2AX, producing M3X2 from M3AX2, and/or producing M4X3 from M4AX3. As shown in FIG. 15, the MXene material may utilize a variety of forms.

In MXene, M could be selected from possible elements such as titanium (Ti), vanadium (V), chromium (Cr), yttrium (Y), zirconium (Zr), niobium (Nb), molybdenum (Mo), hafnium (Hf), tantalum (Ta), and/or tungsten (W), for example. X could be carbon or nitrogen, for example. T may be a functional group (e.g., —OH, —F, ═O, etc.). The MXene could be terminated with oxygen for the chlorine or alternatively bromine.

The MXene conductive layer 122 (or the nanostructured conductive layer more generally) can be intentionally designed as a substantially flat molecule, featuring a carbon backbone with a metallic structure outside. This design allows for various levels of sensitivity and oxidation:

Alternatively, the MXene conductive layer 122 (or the nanostructured conductive layer more generally) may be designed as a 3D structure to support nanoparticles or other imprint layer geometrical structures, such as beads. This flexible design enables the MXene layer to adapt to different applications and requirements within the enhanced electrode system. As mentioned in some variations, gold nanoparticles, silver nano rods, or other conductive nanoparticles may be integrated within a MXene conductive layer 122.

The molecular imprinted polymer (MIP) layer 130 functions as part of a sensing layer in the working electrode 100 wherein analyte molecules are captured in defined cavities formed in the MIP layer 130. The MIP layer 130 plays a crucial role in detecting targeted molecules through its specifically defined cavities.

The MIP layer 130 may use any suitable material for a conductive MIPs, which may include polypyrrole, polyaniline, poly(3,4-ethylenedioxythiophene) polystyrene sulfonate (PEDOT: PSS), polydopamine, and polyphenylenediamine.

The MIP layer 130 includes defined cavities of a targeted molecule. The defined cavities are preferably formed by imprinting targeted molecules. A template molecule which could be the targeted molecule of the analyte, or geometrically similar molecules may be used in forming the molecular imprints. The defined cavities may be prepared or designed to be substantially empty when first used for sensing, allowing for interaction with the analyte (i.e., the targeted molecules). When the analyte is present in the sample, this will result in the molecules of the analyte filling these cavities in some proportion. The concentration of the target molecules in the sample will preferably be proportional to the number of cavities filled during exposure to the analyte. The defined cavities are preferably distributed throughout the polymer material of the MIP layer 130.

The targeted molecule may be various types of molecules. Examples of potential targeted molecule may include a cortisol molecule, Glutathione, Lactic Acid, estradiol, testosterone, Perfluorooctanesulfonic acid (PFOS) and/or other per-and polyfluoroalkyl substances (PFAS). However, the system may be configured for detecting other types of analytes.

In one variation, the MIP layer 130 includes cavities imprinted for sensing a single type of target molecule (or class of molecule).

In another variation, the MIP layer 130 may have cavities imprinted for sensing a plurality of different types of target molecules. In one example, a biosensor that wants to detect presence of any one of a set of monitored molecules could have a plurality of distinct targeted molecules imprinted for sensing. The MIP layer 130 may be formed using a set of template molecules. In one variation, the ratios of template molecule concentrations used in imprinting the polymer material may be adjusted for different sensing characteristics.

A plurality of cavities may be distributed across a sensing surface of the molecular imprinted polymer layer, increasing the likelihood of interactions with the target molecule. The number of cavities also provides the working electrode 100 with sensing capacity. More cavities may mean that the working electrode 100 can be exposed to more of the targeted molecule before being saturated (e.g., substantially all cavities being filled).

The number of cavities can be controlled by adjusting the concentration of emission analyte (e.g., the targeted molecules used as a template) during the imprinting or casting process. This allows for customization of the sensor's sensitivity and saturation point, making it suitable for various applications.

In use, a cavity can be open or filled depending on the presence of target molecules. The filling of a cavity may result in an increase in impedance, while an empty cavity may lead to a lower impedance. The impedance is preferably proportionally changed based on the number or concentration of cavities filled by an analyte. This change in impedance can be measured and analyzed to determine the presence and concentration of target molecules.

In one variation, the MIP layer 130 is deposited as a layer in between the membrane structure 140 and the conductive layer 120. The MIP layer 130 could be substantially flat or an even surface.

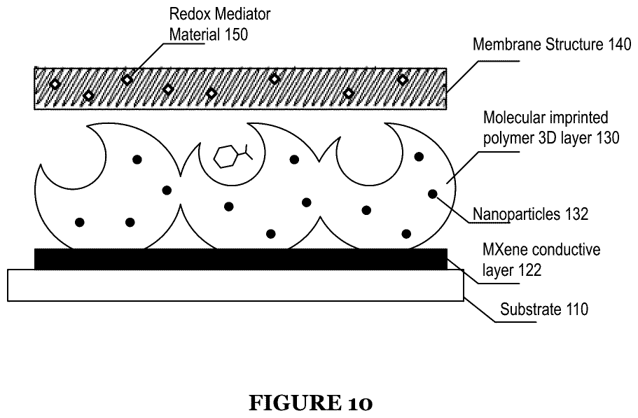

In some variations, the MIP layer 130 may be deposited with a non-flat surface-a structured surface. The structured surface may be used to support better imprinting and capture of targeted molecules. As shown in FIG. 10, the molecular imprinted polymer layer may be formed as shells, beads, or spherical forms (e.g., nanoparticles), such that the cavity can support different types of molecular structures. The spherical forms of the MIP layer 130 may include internal defined cavities where the defined cavities extend into the spherical form. A spherical form may provide defined cavities with additional dimensions. The spherical form may additionally increase the size of molecules that can be targeted. Accordingly, in some variations the MIP layer 130 is a layer of MIP spheres or multidimensional forms. The 3D MIP spheres may be chemically formed. A Polymer or other material may be used to adhere or layer the MIP spheres onto the conductive layer 120.

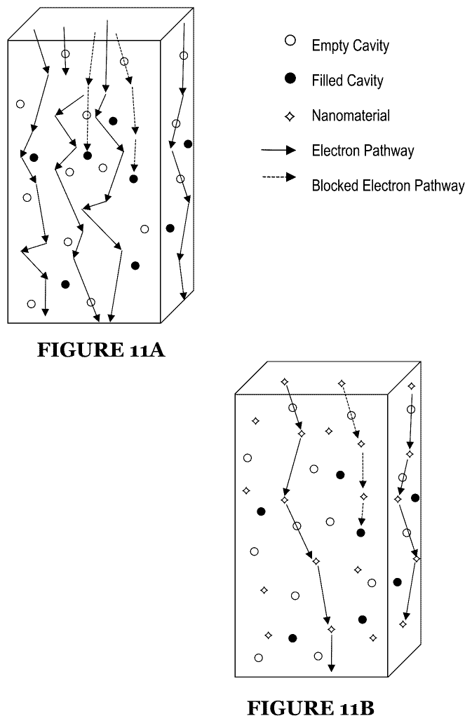

As an additional or alternative variation, the MIP layer 130 may include nanoparticle additives 132, which may function to enhance sensing capabilities. The nanoparticle additives 132 may create lower energy pathways, which can amplify the impact of analyte cavities and unfilled cavities in the MIP layer 130. In variations without integrated nanoparticles, electrical pathways may travel in substantially random paths through the MIP layer as shown in FIG. 11A. Embedded nanoparticles promote pathways that may be easier to block with a molecule captured in a defined cavity. As shown in FIG. 11B, nanoparticles may promote low energy electrical pathways guided by the nanoparticles. In this way, a target molecule captured in a defined cavity can block that pathway to the conductive layer.

The nanoparticles are preferably conductive nanoparticles and may include gold, silver, or other metallic nanoparticles, carbon nanotubes, and/or MXenes (e.g., MXene flakes) that can facilitate a conductive electrical path.

As discussed, by a captured molecules blocking the current, the electrode can detect changes in electrical properties of the electrode (e.g., changes in impedance). With nanoparticles embedded in the MIP layer 130, current can be better obstructed by a captured target molecules due to a lower energy pathway. As shown in FIG. 11B, electrical pathways may be more easily established through pathways formed between nanoparticles and empty cavities. Filled cavities then block electrical pathways which can be seen through more easily detected changes in impedance.

The MIP layer 130 may include one or a combination of different nanoparticles. The nanoparticles may include zero-dimensional nanoparticles, 1-dimensional nanoparticles, 2-dimensional nanoparticles, and/or 3-dimensional nanoparticles. In some variations, the nanoparticles can include carbon-based nanoparticles, carbides (e.g., ceramic) nanoparticles, and/or metallic nanoparticles.

Examples of zero-dimensional nanoparticles may include carbon dots and/or metallicspheres (e.g., silver or gold metallicspheres).

Examples of 1-dimensional nanoparticles may include metallic wires (e.g., silver wires), metal or metal oxide rods, and/or carbon nanotubes (e.g., single or double walled carbon nanotubes).

Examples of 2-dimensional nanoparticles may include graphene, graphene ribbons/lines, and/or rGO (reduced graphene oxide). The 2-dimensional nanoparticles may also include MXene nanoparticles such as MXene flakes. The MXene flakes may be planar sheets or flakes with areas approximately 1 mm by 1 mm though exact dimensions may vary.

Examples of 3-dimensional nanoparticles may include silver nanoprisms, gold nanostars, gold shells, and/or other three-dimensional nanostructures.

In one variation, carbon nanostructures and/or MXenes may be synthesized and then dispersed before polymerization occurs. In another variation, metallic nanoparticles may be created in-situ through electrochemical reduction of metal ions.

In one variation, the MIP layer 130 may additionally or alternatively include redox mediators within its layer, enhancing the electrochemical properties of the sensor and resulting in a more efficient and reliable detection mechanism. The redox mediators may be configured or selected to adjust or modify the electrochemical properties for sensing presence of targeted molecules. As discussed, in some variations, the redox mediator material 150 may alternatively or additionally be integrated in the membrane structure 140.

The redox mediators may function to enable and calibrate the electrochemical reaction during applied potential. The redox mediators can function as a chemical probe used to measure another molecule. When the working electrode 100 is used to enable biosensing capabilities, the redox mediators may facilitate electron transfer between the point of potential application (at the conductive layer such as a MXene layer) and the target molecules. Their properties, such as reversibility, low potential requirement, and selectivity, may be beneficial for efficient and accurate sensing.

In some variations, the redox mediator material 150 may diffuse and/or otherwise be present in the MIP layer 130. In some variations, the redox mediators 150 may be integrated into the membrane structure 140. They may then diffuse with any analyte into the MIP layer 130. Analyte molecules can be captured in defined cavities of the MIP layer 130, which can block redox mediator diffusion to the conductive layer, effectively altering the impedance. In this variation, the MIP layer 130 can be a substantially thin layer. Herein thin may be characterized as being 1-20 nanometers. For example, the MIP layer 130 may be a layer 5-15 nanometers such as 10 nanometers. Using diffusion of the redox mediator through a sufficiently thin MIP layer 130 may function to make an electrochemical sensor with a lower detection level (e.g., enhanced sensing able to detect smaller amounts of an analyte).

In another variation, the redox mediator material 150 can be initially distributed through the MIP layer 130. In this variation, the MIP layer may be a substantially thick layer (comparatively to the variation where redox mediators are initially integrated into the membrane structure 140). Herein, thick may be used to characterize a MIP layer 130 that could be 500 nanometers to more than a micron thick.

The variation for integration of a redox mediator material 150 may depend on the targeted analyte and/or desired sensitivity. For example, a sensor for detection of PFOS may use the variation with the redox mediator material 150 integrated into the membrane structure 140.

The redox mediators are molecules dispersed or included in the MIP layer 130 and/or the membrane structure 140. When the electrode applies potential at the MXene layer the redox mediators react, resulting in oxidation or reduction. Electrons are either pushed or “ripped out” into the redox mediators, creating a current.

The strength of the current depends on the cavities of the molecular imprinted polymer layer. When cavities are full, resistivity increases. When cavities are empty, resistivity is lower or decreases.

Presence of the desired molecules can be determined if the signal goes down, as this indicates the cavities are being filled.

Common redox mediators include methylene blue and Prussian blue. Other redox mediators may alternatively be used. The redox mediator preferably exhibits a substantially reversible electrochemical reactivity count. The redox mediator preferably also is selected/configured for low potentials and non-toxic properties.

High reversibility may be desirable, where oxidation and reduction can cycle with high repeatability. In some implementations, redox mediators may be configured to reduce or oxidize at very low potential (e.g., 0.1 volts), which may extend the sensing lifetime. In some cases, the more often the electrode cycles and gets closer to its maximum potential (e.g., 1 or −1 volts), the more likely it will break, or its performance will degrade. Calibration and/or selection of redox mediators that react at low voltages may function to increase the sensing life of the working electrode 100.

In some variations, the redox mediators may be selected according to the targeted molecule. In some options, multiple varieties of redox mediators may be used. This can enable sensing or targeted multiple molecule types. For example, two or more types of redox mediators may be selected with different response signals. A sensor controller 320 may use the different response signals to improve accuracy of analyte measurements.

The membrane structure 140 functions to protect or safeguard the working electrode 100 from biofouling and/or to stabilize sensing conditions in the MIP layer 130. The membrane structure 140 or an alternative layer or element(s) may be used in maintaining the integrity of the below layers by protecting them (in particular the MIP layer 130) from proteins and other particles that could react or interfere with the molecular imprinted polymer layer. In a similar manner, the membrane structure 140 may additionally function as a filter, preventing larger particles (e.g., macromolecules) such as silica particles or dust from interfering with the molecular imprinted polymer layer.

The membrane structure 140 may additionally regulate both the conductivity and temperature of the solution in contact with the electrode. The membrane structure 140 may additionally function as a vessel for holding and integrating other particles such as the redox mediator material 150.

In some variations, the membrane structure 140 may be a single material layer. In other variations, the membrane structure 140 may include multiple material layers. In some variations, the membrane structure 140 may include or be a hydrogel layer. The membrane structure 140 may additionally or alternatively include an alcogel layer, a cellulose membrane layer, and/or other filter material layers.

The membrane structure may be a variety of different types of hydrogels, which may be selected depending on the use case based on porosity, swelling behavior, mechanical properties, chemical resistance, and/or other specific objectives of the biosensor/electrode application. The membrane structure may be made of PVA (polyvinyl alcohol) or chitosan, though other suitable materials may alternatively be used. The membrane structure 140 may additionally be formed using addition of potassium hydroxide (KOH) or sucrose. KOH is one example of a cross-linker that can be used in forming the hydrogel layer but other suitable cross-linkers may be used. Sucrose in particular may be included when forming the hydrogel layer and then later dissolved so as to establish defined channels through the membrane structure 140. The sucrose forms chains across the hydrogel layer structure and then exposes opened nano/microchannels when the sucrose is removed. The channels in some variations may average 2 micrometers (e.g., 1-5 micrometer channels).

In one variation, the membrane structure 140 may be prepared and formed through hydrolysis of PVA with KOH. A PVA and KOH mixture can be poured into a mold which is then vacuum dried (e.g., at 70 degrees Celsius).

The membrane structure 140 may in some variations be implemented as thin films. Alternatively, the layer may be implanted as pads or a layer/collection of beads. The membrane structure 140 can be a single material or multimaterial structure. Polymers may be blended or modified to improve performance of the membrane structure 140. The membrane structure 140 will generally be a flexible layer. In some variations, the membrane structure 140 can be absorbent, able to swell up to three times a dry thickness (i.e., the thickness when in a dry state).

The membrane structure 140 may be tuned or selected based on desired porosity. Variations in in pore size of the membrane structure may be used to accommodate different target molecules and applications. In some variations, the membrane structure 140 may include defined channels. For example, microfluidic channels or “microtubes” may be defined through the membrane structure 140 to facilitate transport of particles to the MIP layer 130, filtered by particle size based on sizing of the channels. The channels may be on average be 1-5 micrometer in diameter (e.g., around 2 um). The channels may be randomly arranged through structure of the membrane structure 140. The defined channels may help make the sensor work fast for diffusing sample into the MIP layer 130. In some variations, the hydrogel may increase rate of sample absorption by three times.

When integrated as part of a sensing electrode system 200, the membrane structure 140 may additionally extend over and connect with the other electrodes (e.g., the reference electrode 210 and the counter electrode 220). The membrane structure 140 in this way can function as the connective layer between the different electrodes.

Additionally, the membrane structure may exhibit antibacterial properties, effectively preventing fungal or bacterial growth on the electrode surface. This enhances both the durability and accuracy of the device in various environments.

The membrane structure 140 may additionally include additives to balance ionic strength. The membrane structure 140 preferably has an ionic strength similar or otherwise compatible with the expected sample. For example, saliva has an ionic strength in the range of 35 to 235 mM (millimolar). Accordingly, the membrane structure 140 may have an ionic strength 35 to 235 mM. More generally, the membrane structure 140 preferably has an ionic strength that is within an order of magnitude similar to an expected sample. In one variation, the membrane structure 140 may include phosphate buffer saline (PBS) additive which has an ionic strength of approximately 100 mM for 1×PBS.

In some variations, the membrane structure 140 may include an integrated redox mediator material 150. The redox mediator material 150 can be dispersed or otherwise integrated into the membrane structure 140. The redox mediator material 150 can facilitate furthering the protection and normalization of conditions for the electrode. In some variations, the membrane structure 140 may be or include a hydrogel layer saturated with a redox mediator material 150 and a salt so as to promote steady state concentration and a fixed ionic strength. This may be used to prevent variable ionic conditions of a sample from altering the analyte measurement. For example, with the redox mediator material, the membrane structure 140 can mitigate the impact ions in a sample with a high concentration of ions will have on measurement of the analyte at the MIP layer 130. The ions can be captured through ionic interactions with the redox mediator material, thereby preventing or reducing interference with electrochemical impact of the ions within the MIP layer 130.

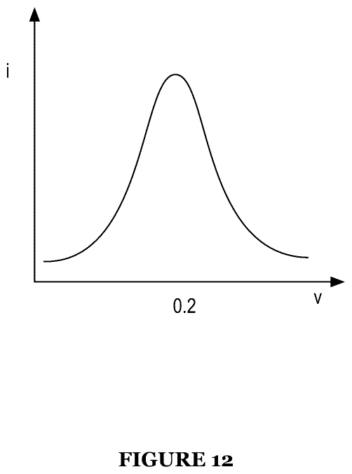

The redox mediator may be various redox mediator materials methylene blue, congo red, a ferricyanide and ferrocyanide, prussian blue, indophenol, diphenylamine, 2,6-Di-tert-butyl-p-cresol, 2,4-Dinitrophenylhydrazine, and/or tetrazolium salts. Accordingly, the redox mediator material may be selected from a group of redox mediator materials consisting of methylene blue, congo red, a ferricyanide and ferrocyanide, prussian blue, indophenol, diphenylamine, 2,6-Di-tert-butyl-p-cresol, 2,4-Dinitrophenylhydrazine, and tetrazolium salts. In one variation, a redox mediator 150 may include a pair of ions functioning as a redox pair. The redox pair may be selected so as to respond roughly at the same potential regardless of the electrode composition. In one example, the redox mediator may include ferricyanide and ferrocyanide as a redox pair. Methylene blue and Prussian blue are other examples of a redox mediator materials 150. Redox pairs may produce measurable current when the electrode reaches a certain potential in voltammetry such as shown in the exemplary voltammetry response in FIG. 12.

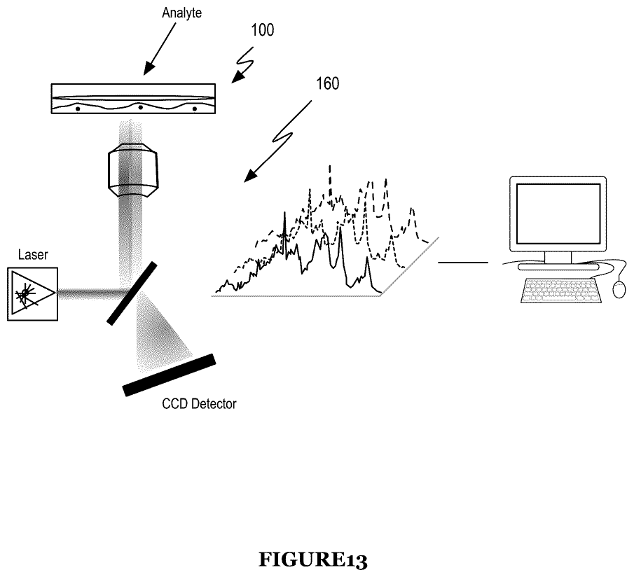

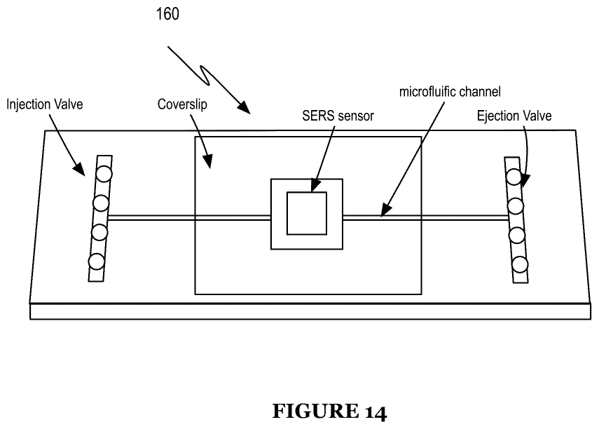

In some variations, a system for the enhanced electrode may additionally include an optical detector system 160 that can be used in combination with electrochemical sensing. The optical detector system 160 may provide an optics-based signal related to presence of the targeted molecule. In one variation, the optical detector system 160 may use Raman spectroscopy as shown in FIG. 13. In an optical system using Raman spectroscopy, an element applies a light and measures scattering of light caused by presence (and/or lack of presence) of molecules in the molecular imprinted polymer layer 130. In this way, the optical detector system 160 is directed to perform Raman spectroscopy through the molecular imprinted polymer layer. In another variation, as shown in FIG. 14, the optical detector system 160 may use a SERS (surface-enhanced Raman spectroscopy) sensor system using a laser to amplify a response.

In some alternative embodiments the working electrode 100 may be integrated into a sensing electrode system 200. A sensing electrode system 200 of one preferred embodiment may include an enhanced working electrode (100), a reference electrode 210, and a counter electrode 220 as shown in FIG. 7. The sensing electrode system 200 functions to provide a full sensing system where the enhanced electrode described herein can use additional electrodes to provide calibration and reference signals for better interpretation of the measurements from the enhanced electrode.

As the working electrode may lend itself to 2D printing/deposition fabrication, the other electrodes may similarly be constructed using 2D printing and/or deposition fabrication techniques. Accordingly, the working electrode (or more specifically the conductive layer of the working electrode), the reference electrode, and the counter electrode, may be printed on a shared substrate surface. The membrane structure 140 or optionally a sub-layer of the membrane structure 140 of the enhanced working electrode 100 may extend over and similarly be an outer layer covering the reference electrode 210 and the counter electrode 220. In this way, the membrane structure 140 may be the connective layer between all electrodes.

The sensing electrode system 200 may be used as part of a potentiostat. In a potentiostat variation, current is flowed through the sensing electrode system 200 from the counter electrode 220 to the working electrode 100 from which current and/or impedance may be measured. Additionally a voltage potential difference may be measured between the reference electrode 210 and the working electrode 100.

The electrode system 200 may be a single electrode used within some other system. In some variations, an array or plurality of the electrode system may be used to provide multiple points of measurement. In some cases, different electrode systems 200 in a set of electrode systems may be configured for sensing different targeted molecules.

The enhanced working electrode 100 functions to provide a primary sensing of an electrochemical reaction with a targeted molecules to monitor presence of an analyte. The enhanced working electrode 100 is preferably one such as described herein.

The reference electrode 210 functions to provide a reference potential against which the potential of a working electrode may be compared and measured. It may provide a zero potential reference. The reference electrode may be made of a stable material such as silver or silver chloride. In one variation, it may be produced and formed using silver ink. Any alternative electrode material may be used.

The counter electrode 220 functions to complete an electrical circuit in the sensing electrode system. The counter electrode 220 may serve as a source or sink for current involved in a redox reaction occurring at a working electrode. The counter electrode, in some variations, may be made using carbon, gold, or other suitable material.

The three electrodes may be all printed and/or deposited as a sensing system stack on a shared substrate. The working electrode 100 may use the electrochemical sensing electrode stack described herein. The reference electrode 210 and/or the counter electrode 220 may be made from conductive ink printed on the substrate 110. The three electrodes will generally be conductively isolated such that the conductive layers of each electrode do not touch, thereby establishing a short in the system. Each electrode may connect independently through a potentiostat. The electrodes of the potentiostat may have various geometrical forms. In some variations, such as when printed or otherwise formed on a flexible substrate, the electrodes may be produced with non-linear paths such as using squiggly patterns, zig-zag patterns, or other geometric patterns, which can function to make the electrodes more resilient to bending.

The electrode system 200 may be implemented in various form factors. The sensing electrode system 200 in one variation may be an electrode system 200 implemented or built within some other system. In some variations, the sensing electrode system 200 may be integrated as part of a testing patch/strip, cartridge, module, or some other testing sampler. A sample collection and management system 310 may be used to control how a sample is exposed to or otherwise put into contact with the sensing electrode system 200. Additionally or alternatively, the sensing electrode system 200 will preferably be conductively coupled and integrated with a sensor controller 320.

In another alternative embodiment, one or more sensing electrode systems 200 may be used within a sensor device 300 (e.g., a biosensor device). A sensor device 300 of one preferred embodiment can include one or more sensing electrode systems 200 integrated with a sample collection and management system 310 and a sensor controller 320 as shown in FIG. 8. The sensor device 300 may be designed with various form factors.

The sensor device 300 is preferably implemented in some form factor for the intended use. Accordingly, the sensor device 300 may include a body, frame, or some other suitable structure element(s) that adapt the device for its intended use.

In one exemplary variation, the sensor device 300 may be a wearable device. In one such variation, the wearable sensor device 300 could include or be part of an adhesive patch.

In another variation, the wearable sensor device 300 could be a sensor element attached to or integrated into some other wearable device. The sensor element could be positioned to come into contact or be exposed to an analyte in a sample. As such, in some variations, the sample may be passively collected. For example, as a wearable sensor device 300, sweat of a user may be collected and directed to the sensing electrode system 200 by a sample collection and management system 310.

In another exemplary variation, the sensor device 300 includes a body or frame that holds the various components of the biosensor and may include some structure or components to facilitate collection or testing of a sample. The body could be any suitable shape or form and may be made of a variety of materials. The sensor device 300 may be configured as a testing device where a sample can be deposited or applied to the device and then sensed.

In another exemplary variation, the sensor device could be configured as a device that is worn inside the mouth or that a user breathes into.

Any other suitable form factor or implementation may alternatively be used.

In some variations, the sensor device 300 may be a single use device but may alternatively be a multi-use device. As a multi-use device, the sensing electrode system 200 may be a removable component or be integrated into a removable cartridge or component. Multiple tests may be performed by changing the sensing electrode system 200 in the sensor device 300. In this way, a sensor device 300 may also be able to perform different tests depending on the type of sensing electrode system 200. For example a sensor device 300 may detect test a first sample for a first type of analyte using one sensing electrode system 200 (with a MIP imprinted with target molecules of the first type of analyte) and then used to test a second sample for a second type of analyte using another sensing electrode system 200 (with a MIP imprinted with target molecules of the second type of analyte).

In some variations, an electronic or machine-readable identifier may be included with the sensing electrode system 200, and the sensor device 300 can read or detect the machine-readable identifier. The identifier may signal use or operation to be used with a sensing electrode system 200. The sensor controller 320 can then adjust sensing based on the identifier. For example different voltammetry signals may be generated depending on the type of sensing electrode system 200. In alternative variations, a user interface may be used to indicate the type of sensing electrode system being used.

The sensor device 300 may additionally track usage of a sensing electrode system 200 so as to monitor when the sensing electrode system 200 has reached an end-of-life state. Some sensing electrode systems 200 may be usable multiple times depending on the number of samples, volume of samples, quantity of detected analyte, and/or electrical signal conditions in the working electrode 100.

A sensor device 300 system may include one or more sensing electrode systems 200, where the sensing electrode system 200 can be some variation of the sensing electrode system described herein. The sensing electrode system 200 is preferably integrated into the sensor device 300 and oriented to analyze a sample.

In one variation, the sensing electrode system 200 may be directly integrated into a structure of the sensor device 300. In another variation, one or more sensing electrode system 200 could be replaceable such that replacement electrode sensor systems can be swapped in after one sensing electrode system 200 has reached its end of use and/or if a new type of sensing electrode system 200 is needed (e.g., needing to test for a different analyte)

The sample collection and management system 310 (i.e., a sample collector) functions to facilitate management of a sample. This may be any suitable system or component that handles directing a sample for analysis by an enhanced electrode. In one variation, the sample collector 310 may be a microfluidic system that receives a sample in one region and then channels it to or over an enhanced electrode. In one exemplary implementation the sample collector 310 may include a paper microfluidic channel that routes a sample over a sensing electrode system. This may be a passive system but could alternatively be an active system where samples are actively moved in a controlled manner.

The sensor device 300 system may additionally include a sensor controller 320 which functions to integrate with and control a sensing electrode system. The sensor device system preferably controls when and how testing is performed. The sensor controller can apply the various voltage potentials to collect readings from the working electrode and the counter electrode.

In one variation, the sample controller 320 can collect multiple test readings. Square wave voltammetry, differential pulse voltammetry, and/or other suitable testing approaches may be used to collect measurements from the sensing electrode system 200.

In a variation that includes an optical system, then the sensor controller 320 may additionally manage control and collection of sensor data from the optical system. The controller 320 or some other device may process data and generate some sensor output.

The sensor device 300 may include any other suitable components to enable various other features. For example, the sensor device 300 may include a battery or power source to power the sensing. The sensor device 300 may include a communication device or component to relay information or data to a connected computing device.

The sensor device 300 may include one or more user interface components such as an output like a display or speaker and inputs such as buttons or other forms of user input. This may be used to receive control input or present sensed information.

In one variation, the enhanced working electrode 100 may include a membrane structure 140 that is a multilayer membrane structure. The different layers of the membrane structure 140 may function to facilitate filtering a sample, concentrating targeted analyte, and/or otherwise facilitating better collection of a sample for sensing. Such a multilayer membrane structure may include multiple gel layers. A system variation using a multilayer membrane structure can include at least an external membrane layer 142 and a concentrating membrane layer 144 adjacent to a sensing structure 102 (e.g., a MIP layer for a nanostructure-based sensor electrode) as shown in FIG. 1. The external membrane layer 142 and the concentrating membrane layer 144 are configured to have different analyte solubilities thereby promoting diffusion, containment and/or concentration of an analyte in the concentrating membrane layer 144.

The multiple membrane (or gel) layers may utilize different solvents to achieve a separation through equilibriums to enforce desired concentration of an analyte. A targeted analyte can be more soluble in the concentrating membrane layer 144. Concentrating molecules of an analyte at the concentrating membrane can make it easier to perform an electrochemical and/or optical measurement.

In some variations, the external membrane layer 142 is a hydrogel layer and the concentrating membrane layer 144 is an alcogel layer. As an example, if the targeted analyte is cortisol which is less soluble in water than in ethanol or methanol, having an external hydrogel layer 142 and a concentrating alcogel layer can promote concentration of cortisol within the alcogel concentrating membrane layer 144. This can also be the case for other hormones that have phenol groups or alcohol groups.

Alternative arrangements of types of gels may alternatively be used as sublayers of a multilayer membrane structure 140 depending on the targeted analyte and its solubility in different solvents.

The membrane structure 140 can be or act as a membrane guard layer which may use a variety of different types of gels. The gels may be selected depending on different applications based on porosity, swelling behavior, mechanical properties, chemical resistance, and/or other specific objectives of the sensor/electrode application. The membrane guard layer may be made of PVA (polyvinyl alcohol) or chitosan, though other suitable materials may alternatively be used. The membrane guard layer is preferably implemented as thin films. Alternatively the layer may be implanted as a pad or a layer/collection of beads. The guard layer can either be a single or multi-material layer. Polymers may be blended or modified to improve performance as a guard layer.

In one variation, PVA and/or chitosan may be used in both external and concentrating layers. The recipes (e.g., concentration of sucrose, KOH, and other properties) may be adjusted to target different wicking vs concentration layering benefits respectively.

The external membrane layer 142 functions as a primary layer. The external membrane layer 142 preferably includes at least one surface that is externally facing and can be exposed to a sample. For example, the external membrane layer 142 may be the top layer of the membrane structure 140 and be the surface that is contacted with the skin, saliva, or other source of a sample for a biosensor. In another case, the external membrane layer 142 may be the top layer of the membrane structure 140 and be the surface that is contacted with an environmental sample.

The external membrane layer 142 may be a material with a matrix structure. The external membrane layer 142 can have a solvent infused within a matrix structure wherein the targeted analyte has lower solubility with the solvent (relative to the analyte's solubility in a solvent of the concentration membrane layer 144).

As mentioned in some variations, the external membrane layer 142 may be a hydrogel layer, which is a membrane layer that has a water-based solvent within its matrix structure. A membrane layer with a water-based solvent (i.e., a hydrogel layer) may be paired with a concentrating membrane layer 144 that is an alcogel layer. In a hydrogel, the swelling agent is water, and the network component of the hydrogel is, in some variations, a polymer network.

In some variations, the external membrane layer 142 may also be a paper filter layer. A paper filter layer can be a cellulose membrane that contains no solvent for safe contact, with a hydrophilic area contained in a specific shape to allow collection of a sample to filter through a precise sample area, reducing the amount of sample needed for measurements.

A paper filter layer would be a 2D plane, shaped to the shape of the electrode/substrate (e.g., the sensing structure 102), this plane may be specific to up the threshold of volume of sample volume uptake of ˜100 uL that is filtered through gravity filtering. In one exemplary variation, depending on the particulate composition of an expected sample, there may be multiple paper filter layers for decreasing particle size filtering, but they would be filter papers joined with an adhesive spacer around the frame of the filter paper. All layers would have an adhesion spacer framing the plane without obstruction of a gravitational path to the electrodes.

The external membrane layer 142 may include microfluidic channels to facilitate collection of a sample and diffusion of the sample (e.g., via capillary forces) into the matrix of the membrane structure. In one variation, microfluidic channels could be random for general dispersion. In another variation, the microfluidic channels may be at least partially directed to an interfacing boundary with the concentrating membrane layer 144. The interfacing boundary may be an at least partially solid boundary so that the analyte can be allowed to diffuse into the concentrating membrane layer 144 or the next adjacent membrane layer. Should the device lay flat on a table, the external membrane layer 142 may also include cellulose and glass microfiber filter paper that allows for gravity filtering.

The concentrating membrane layer 144 functions as a second, underlying layer that has higher analyte solubility. The polarity of the concentrating membrane layer 144 may be adjusted to improve concentration of a targeted analyte within the concentrating gel. For example, cortisol and ethanol are relatively non-polar, and the concentrating membrane layer 144 could be adjusted to account for this characteristic of polarity.

The concentrating membrane layer 144 is preferably adjacent on one face to the external membrane layer 142 or an optional intermediary membrane layer and/or interface. On an opposing face, the concentrating membrane layer is adjacent, next to, or otherwise positioned for enhanced sensing by a sensing structure 102. In particular, the concentrating membrane layer 144 may be adjacent to a MIP layer 130 within the enhanced electrode described herein.

The concentrating membrane layer 144 may be a material with a matrix structure. The concentrating membrane layer 144 can have a solvent infused within its matrix structure where the targeted analyte has higher solubility with the solvent (relative to the analyte's solubility in a solvent of the external membrane layer 142).

As mentioned in some variations, the concentrating membrane layer 144 may be an alcogel layer, which is a membrane layer that has an alcohol-based solvent within its matrix structure. The alcohol solvent may include alcohols such as methadone, methanol, or ethers.

An alcogel layer variation of the concentrating membrane layer 144 may have a thickness that is adjusted according to applications. Thickness (or thinness) will affect the diffusion of the sample. This may be a useful design variable when designing for microfluidics. A microfluidic architecture that allows flow of a sample may additionally be used to help saturate the alcogel layer with an analyte.

In one variation, the concentrating membrane layer 144 may be made from a paper filter layer or some other cellulose-based membrane layer. A paper filter layer or other alternative concentrating membrane layer 144 may be configured in part based on properties like wet strength, porosity, particle retention, volumetric flow rate, compatibility, efficiency and capacity so as to function as a good concentrating membrane layer.

Another potential variable within the system would be the polarity of the solvent in the membrane layer and how that polarity relates to the sample/analyte. For example cortisol and ethanol are relatively nonpolar. Adjusting the polarity of the solvent in the membrane can improve or enhance concentration. In some variations, the system may enable selectively sensing polar analytes by adjusting the ratio of polar to non-polar solvents in an alcogel mixture and target the selective solubility of the analyte.

In some variations, the concentrating membrane layer (or an alternative layer adjacent to the sensing structure 102) may be specially prepared to interface with the sensing structure 102 (e.g., the MIP layer 130). The concentrating membrane layer may be a hydrogel that is dried flat onto the electrode, which may function to eliminate use of adhesion during wicking process. The hydrogel may be made with a mixture of deionized water, polyvinyl alcohol (50%), potassium hydroxide (40%), and sucrose (10%). Varying sucrose concentrations allows for custom channel sizes for hydrogel layers, allowing custom filtering of target analytes. To use in tandem with the sensing surface for wicking purposes, the hydrogel, once polymerized, is neutralized in deionized water. While saturated with deionized water, the hydrogel is placed onto a MIP modified electrode and slowly dried flat, allowing water to evaporate, leaving a MIP modified electrode with a dried hydrogel that will expand until maximum saturation volume is achieved upon uptake of target sample.

In some variations, the multilayer membrane structure may additionally include one or more intermediary membrane layers. An intermediary membrane layer could similarly have its own analyte solubility.

In one exemplary example, a multilayer membrane structure 140 may include a dried filter paper as an external facing layer that does initial filtering for large particulates, followed by a hydrogel layer that wicks a sample and rehydrates, and a third layer that has a dried filter paper impregnated with stable redox mediator that provides an initial spike of redox mediator, followed by another polymer layer saturated with redox mediator that provides a primary bulk solution that the electrochemistry occurs in.

In some variations, the multilayer membrane structure may include distinct membrane layer subregions which may be configured with distinct analyte solubilities. This may be used when a sensor is targeting multiple different analytes, and different concentrating membrane layer sub-regions may be configured to concentrate different analytes into different regions so that each may be individually measured. Microfluidic channels may be used to facilitate channeling samples to the different sub-regions.

In some variations, each membrane layer of a multilayered membrane structure may be configured for differing functions in order to eliminate or mitigate interference. In one example, a multilayered membrane structure may include a layer stack comprising an externally exposed dry hydrogel, a glass microfiber pad, and a cellulose pad impregnated with redox mediator components (i.e., “redox probes”). The cellulose pad would be adjacent to (“on top of”) the MIP layer 130. The dry hydrogel may enhance wicking samples, which can be filtered through the glass microfiber pad, and then filtered through a cellulose pad impregnated with the redox mediator components, allowing for a refined sample that prevents biological fouling of the sensitive electrode surface of the MIP layer of the sensing structure 102.

A system variation using an infused redox mediator may include the membrane structure 140 adjacent to a sensing stack, wherein the membrane structure 140 is infused with a redox mediator material or materials as shown in FIG. 2.

This variation functions to leverage the membrane structure 140 to have a stable source of redox mediator components while not embedding the redox mediator into the sensing structure stack (e.g., the MIP layer) which can risk damage to the sensor or lowering the sensing capabilities.

The redox mediator material 150 may be diffused into the membrane structure 140 in a variety of ways. In one variation, the redox mediators may be allowed to diffuse into the membrane layer before assembling. In a variation where the redox mediator is allowed to diffuse, the redox mediator may be preconcentrated on a cellulose layer. When in contact with the liquid sample, the cellulose paper is rehydrated and the concentrated redox mediator is allowed to diffuse through the paper and further down into the bulk solution at the electrode interface. In another variation, a porous micro or nanostructure may be loaded with a redox mediator and where this component releases redox mediator to compensate for any losses experienced by the mediator diffusing into a concentration layer of the gel, thereby keeping a stable concentration mediator. This may be useful for a long-term sensor where the sensor is used over a longer period of time, and which may be used multiple times.

In another variation, the membrane may be loaded with redox mediator with a maximum sample retention. Sample retention relates to the volume retention of the polymer layer and/or of the filter paper. When rehydrated, the hydrogel and/or the filter paper will retain a specific volume and size of particle depending on the pore size and thickness of the layer, which can then determine the maximum specific volume of redox or sample that the layers can hold. Pass peak retention, the sample volume will mix with the redox mediator to introduce the redox probe enhanced sample at the MIP sensing interface.

In some variations, a multilayer membrane structure 140 may be used. Max saturation levels may be reached within each layer, which could allow different variations of redox saturation.

Within a sensor electrode, the redox mediators may function to enable and calibrate the electrochemical reaction during applied potential. When the enhanced electrode is used to enable sensing capabilities, the redox mediators may facilitate electron transfer between the point of potential application (at the nanostructure sensing layer) and the target molecules. Their properties, such as reversibility, low potential requirement, and selectivity, may be beneficial for efficient and accurate sensing.

A system variation enabling multiple redox mediator response signals may include a working electrode 100 that includes multiple redox mediators 150, where the redox mediators have distinguishable response signatures as shown in FIG. 3. This system may additionally include a sensor controller 320 or some other type of analysis engine that may be used to analyze a measured response.

The different redox mediators 150 may be integrated within the membrane structure 140 and/or integrated into solid state MIP sensors (e.g., the MIP layer 130) as shown in FIG. 4. In some variations, multiple different redox mediators 150 may be used in a multilayered variation of the membrane structure 140. The different redox mediators 150 may be used within the same layer or different layers of a multilayered membrane structure 140.

In one variation, multiple redox mediators 150 are used within a membrane layer of the membrane structure 140. In some further variations, the different redox mediators 150 may be used within the same or different sublayers of a multilayered membrane structure. Alternatively, different redox mediators 150 may be used within a single membrane layer.

In another variation multiple redox mediators may be used within the MIP layer 130.

In other variations, one or more type of redox mediator may be used within a membrane structure 140 and one or more type of redox mediator may be used within the MIP layer 130, where these types of redox mediators are different specially configured. For example, a membrane layer of the membrane structure 140 may include a more stable biocompatible redox mediator and the MIP layer may include a more efficient but less biocompatible redox mediator.

This variation may involve or be used with a method of operation that includes preparing and/or providing a chemical sensor with two or more redox mediators, performing a voltage sweep, measuring current response and detecting response data which may indicate multiple current peaks, and then analyzing the response data to determine analyte presence and/or concentrations.

Accordingly, in such a variation, a sensor controller 320 may include instructions specially configured such that when executed cause the sensor controller 320 to perform operations that include: performing a voltage sweep, measuring current response and detecting response data which may indicate multiple current peaks, and analyzing the response data to determine analyte presence and/or concentrations.

In variations that use a single redox mediator, a voltage sweep can be performed using an electrode and a responding current is measured. The voltage sweep will in an exemplary response signature have a diffused peak. When the potentiostat applies potential between the electrodes (e.g., at the nanostructured sensing layer or MXene layer) the redox mediators react, resulting in oxidation or reduction. This in turn results in a peak in current for a voltage sweep. Measuring the difference in peak current of the redox mediator can correspond to a measurement of the concentration of the analyte. This linear or non-linear profile is what is used to determine concentrations.

The system as an additional or alternative approach may use two or more different redox mediators that have different response signatures. Different response signatures are used to characterize how the diffused peak of one redox mediator is separate and able to be distinguished from the diffused peak of a second redox mediator.

As a result, the multiple peaks in the current response can be used to collect redundant measurements of concentration. This may be used to calibrate the response curve. An analysis system such as the sensor controller 320 may be used to perform linear regression or multivariate machine learning regression, and/or other data analysis processes.

The variation may include any suitable number of redox mediators. The redox mediators may be selected so that expected peaks are within some window threshold to avoid overlapping and to avoid being too far apart. The applied potentials will preferably be within the solvent stability windows. In some exemplary implementations, the peaks should occur between negative 0.9V and positive 1.2V.

The redox mediators may be added with equal or similar concentrations. However, some variations may alternatively have configured different concentrations to balance signals from different redox mediators which may have different signal responses. This may be used to help multiple peaks be distinguished and their changes can be observed with respect to the concentrations of a targeted analyte.

### 3. Method

Various methods of production and/or operation may be used in connection with the system(s) described herein. Herein are described methods for manufacturing, assembly, and/or operation of a working electrode.

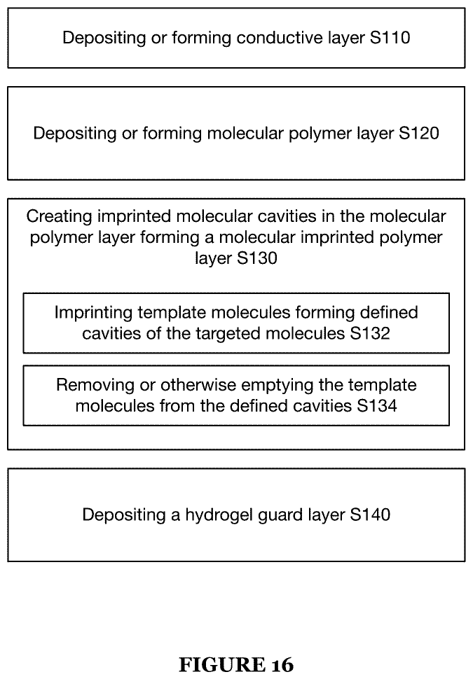

A method S100 for producing an enhanced working electrode may include, as shown in FIG. 16, depositing or forming a conductive layer S110; depositing or forming a polymer layer S120 and creating imprinted molecular cavities in the molecular polymer layer forming a molecular imprinted polymer layer S130; and depositing a membrane structure S140. Block S130 may more specifically include imprinting template molecules forming defined cavities of targeted molecules S132 and then removing the template molecules or otherwise emptying the defined cavities S134.

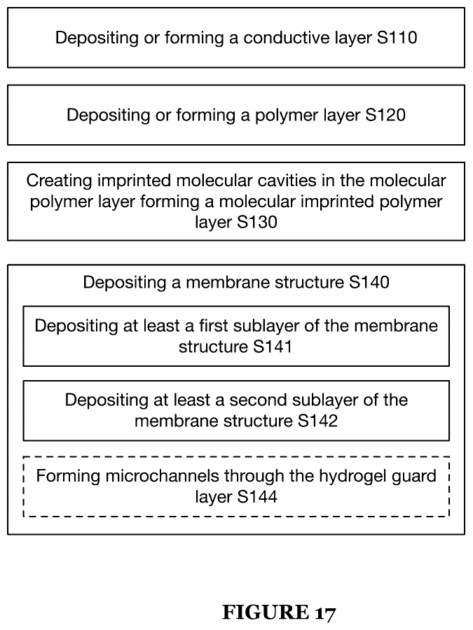

As shown in FIG. 17, in one variation, the method may be adapted for producing an enhanced electrode with a multilayered membrane structure. In such a variation, the method may include: depositing or forming a conductive layer S110; depositing or forming a polymer layer S120 and creating imprinted molecular cavities in the molecular polymer layer forming a molecular imprinted polymer layer S130; and depositing a membrane structure S140, which comprises depositing at least a first sublayer of the membrane structure S141 and depositing at least a second sublayer of the membrane structure S142.

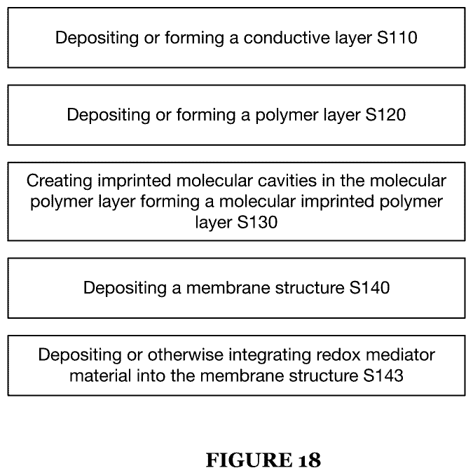

As shown in FIG. 18, in one variation, the method may be adapted for producing an enhanced electrode wherein the redox mediator material is integrated into the membrane structure. In such a variation, the method may include: depositing or forming a conductive layer S110; depositing or forming a polymer layer S120 and creating imprinted molecular cavities in the molecular polymer layer forming a molecular imprinted polymer layer S130; depositing a membrane structure S140; and depositing or otherwise integrating redox mediator material into the membrane structure S143.

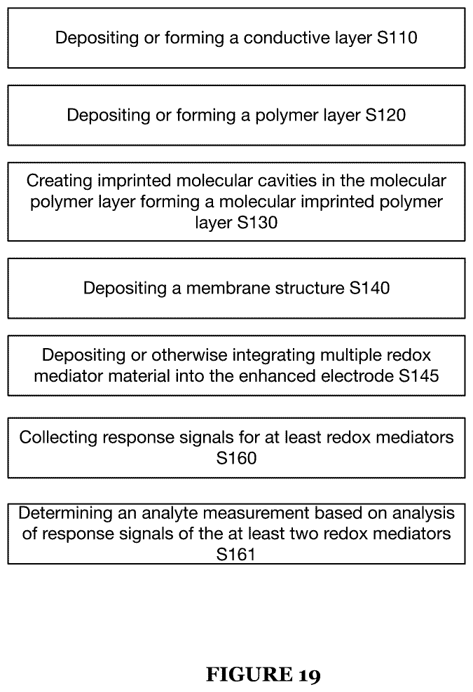

As shown in FIG. 19, in one variation, the method may be adapted for producing an enhanced electrode with multiple redox mediators. In such a variation, the method may include: depositing or forming a conductive layer S110; depositing or forming a polymer layer S120 and creating imprinted molecular cavities in the molecular polymer layer forming a molecular imprinted polymer layer S130; depositing a membrane structure S140; and depositing or otherwise integrating multiple redox mediator material into the enhanced electrode S145. This may include adding two or more different types of redox mediators into the MIP layer and/or the membrane structure.

Accompanying this method of production may include a method or process of operation whereby reading of response signals from two or more redox mediators may be used to produce an enhanced analyte measurement. Accordingly, a method for using the working electrode may additionally or alternatively include collecting response signals for at least redox mediators S160 and determining an analyte measurement based on analysis of response signals of the at least two redox mediators S161 as shown in FIG. 19.

Additionally or alternatively, the method and more specifically depositing the membrane structure S140 may include forming microchannels through the membrane structure S144. The method may additionally include depositing or otherwise integrating nanoparticles into the MIP layer S136.

Various other features of the enhanced electrode may additionally be produced or formed through such a method of production.

Block S110, which includes depositing or forming a conductive layer, functions to form the conductive layer of an enhanced working electrode. The conductive layer is preferably deposited onto a substrate surface. The substrate as described herein may be rigid or flexible. The substrate may also be a planar surface or non-planar surface. Depositing or forming the conductive layer may more specifically include printing a conductive ink or material. Printing may include, for example, printing using an inkjet printer or screen printing or mask printing techniques.

The conductive may, for example, be made of a MXene material, a MXene carbon material, carbon black ink, graphene ink, silver ink, and/or gold ink. In some variations, depositing a conductive layer may include printing multiple sublayers. In one variation, this may include printing a base layer of MXene or MXene carbon layer on top of the substrate layer and then depositing or printing a second conductive layer on top of the base layer. The second conductive layer may be formed by printing a layer of gold or silver ink on top of the base layer.

Block S120 and S130, which includes depositing or forming a polymer layer and creating imprinted molecular cavities in the molecular polymer layer forming a molecular imprinted polymer layer, function to form a MIP layer with defined cavities designed to capture targeted molecules of an analyte. Block S130 may more specifically include imprinting a template molecule forming defined cavities of targeted molecules S132 and then removing the template molecules or otherwise emptying the defined cavities S134. The template molecules may be the targeted molecules but may also be or include other molecules of similar or compatible geometries to form cavities that are suitable capture of the targeted molecules. Removing the template molecules can involve various processes such as washing or rinsing the formed MIP layer to physically remove the template molecules, introducing a chemical or reagent to breakdown the template molecule, and/or creating environmental conditions to breakdown the template molecule (e.g., changing pH, temperature, light conditions, etc.).

As discussed herein, in some variations, a thin MIP layer may be desired such as in variations, where a redox mediator is integrated into the hydrogel layer. In this variation, building of the MIP layer may use 10-15 cycles. If a thicker MIP layer is desired such as when the redox mediator is directly integrated into the MIP layer initially, then more than 15 cycles may be used to build a thick MIP layer (e.g., 500 nm to 1 micron thick).

In some variations, the MIP layer may include nano or micro-meter defined channels. In one variation, nano or micro structures may be formed or integrated into the MIP layer by initially placing nanostructures and then polymerizing on top. In another variation, polymerization may be initially performed when a nanostructure is in solution with a monomer to trap nanostructures within the resulting polymeric matrix.

Block S140, which includes depositing a membrane structure, functions to form a membrane structure in between the MIP layer and the external environment. The membrane structure may be layered directly on top of the MIP layer but there could alternatively be intermediate layers.

As mentioned, in some variations, the enhanced working electrode may have multiple layers. In such a variation, depositing the membrane structure S140 may more specifically include depositing a multilayered membrane structure thereby forming a multilayered membrane structure such as described herein.

Accordingly, depositing a membrane structure S140 may include depositing at least a first sublayer of the membrane structure S141 and depositing at least a second sublayer of the membrane structure S142.

The multilayered membrane structure in some variations may include an external membrane layer and a concentrating membrane layer. As such, depositing a membrane structure S140 may include depositing at least a concentrating membrane layer of the membrane structure S141 and depositing an external membrane layer of the membrane structure S142.

The first sublayer (e.g., the concentrating membrane layer) may be deposited onto a sensing structure of the working electrode, such as onto the MIP layer.

The second sublayer (e.g., the external membrane layer) may be deposited as an external layer, where one face of the second sublayer is exposed externally. An external membrane layer may have a surface onto which a sample is collected.

In some variations, the membrane structure may benefit from including redox mediator materials. Accordingly, block S140 may include depositing or otherwise integrating redox mediator material into the membrane structure S143.

One (or more) redox mediator materials may be integrated within a membrane structure made of one membrane/guard layer material. Alternatively, one or more redox mediator materials maybe integrated within multiple layers of a membrane structure wherein redox mediator materials are used with a multilayered membrane structure.

In some variations, the membrane structure may form a uniform matrix. In other variations, the membrane structure may include microchannels. The microchannels may be formed so as facilitate directed flow of a sample. The channels may be sized and/or formed so as to help filter passing elements from a sample to the MIP layer. Accordingly, block S140 may additionally or alternatively include forming microchannels through the membrane structure function S144.

In some variations, depositing a membrane structure may additionally include adding an additive to calibrate an ionic strength of the membrane structure to a compatible range of a sample. A compatible range can be within an order of magnitude of the range of ionic strength of expected samples. In some variations, this may include adding PBS to target a range 35 to 235 mM (e.g., around 100 mM).

In some variations, multiple redox mediators may be used whereby the method include collecting response signals for at least redox mediators S160 and determining an analyte measurement based on analysis of response signals of the at least two redox mediators S161 as shown in FIG. 19.

The two or more redox mediators may be material types that have differing response signatures. In particular, the diffused peak response signals of the redox mediators are preferably offset such that a first diffused peak response signal of a first redox mediator can be distinguished from a second diffused peak response signal of a second redox mediator. This may provide a way for redundant quantification/measurement of an analyte. The measurement of the analyte may be calibrated, corrected, and/or otherwise enhanced using the two or more different peak responses.

Block S161, which includes determining an analyte measurement based on analysis of response signals of the at least two redox mediators may include analyzing signals from the working electrode to generate a measurement result. Analyzing can include performing linear regression, performing multivariate machine learning regression, and/or performing other data analysis processes. A resulting measurement of the analyte can preferably be produced. This processing may be performed by a sensor controller or other suitable processing system. These method variations may additionally be performed in connection with or separate from a method of producing a working electrode, an electrode system, and/or a sensor device.

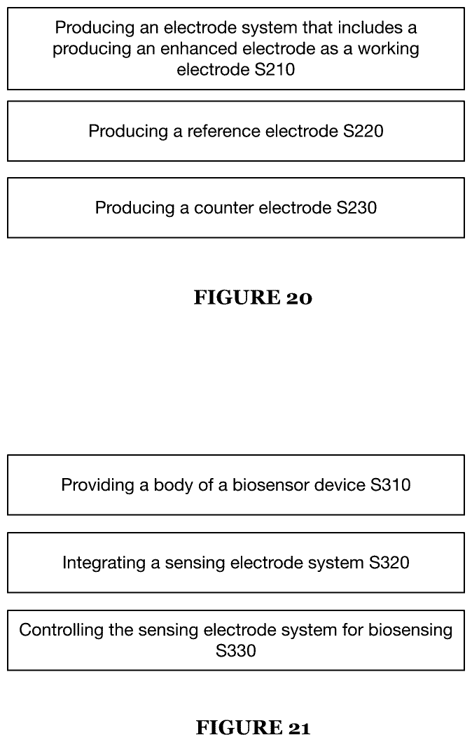

A method S200 for producing an electrode system may include, as shown in FIG. 20, producing an electrode system may include a producing an enhanced electrode as a working electrode S210, producing a reference electrode S220, and producing a counter electrode S230. Various manufacturing methods may be used as part of producing these electrodes. Producing the enhanced electrode may include the variations described herein for method S100. This method S200 may be used in creating a sensing electrode system as described herein.

A method S300 for producing and/or operating a sensor device system, as shown in FIG. 21, may include providing a body of a sensor device S310, integrating a sensing electrode system S320, and controlling the sensing electrode system for biosensing S330. A sensing electrode system may be produced or formed using method S200 described herein. Integrating a sensing electrode system S320 may permanently integrate the sensing electrode system, which may be the case where the sensor device is designed to be used with one particular sensing electrode system like in a single use system. In other variations, the sensing electrode system may be interchangeable. In such variations, integrating the sensing electrode system may include receiving a replaceable sensing electrode system.

For a sensor device system usable with replaceable sensing electrode systems, the method may additionally include operations for tracking and taking action to initiate or prompt changing of the sensing electrode system. Accordingly, the method may include tracking usage of the sensing electrode system and triggering an electrode change event upon satisfying a usage condition. The electrode change event may be an alert or indicator to communicate a recommended change of the sensing electrode system. The electrode change event may additionally or alternatively include automatically discharging a current sensing electrode system and loading a new sensing electrode system.

In one variation, tracking usage of the sensing electrode system and triggering an electrode change event upon satisfying a usage condition may include counting the number of sample analyses and triggering the electrode change event when the number of sample analyses is at and/or greater than a set threshold. In other variations, the quantity of an analyte measured for a sensing electrode system may be used. A sensing electrode system may have so much capacity for an analyte and so when the available capacity reaches some upper threshold the system can prompt a user to change the sensing electrode system. The volume or other measure of processed sample may be an additional or alternative property used to determine when to trigger an electrode change event.

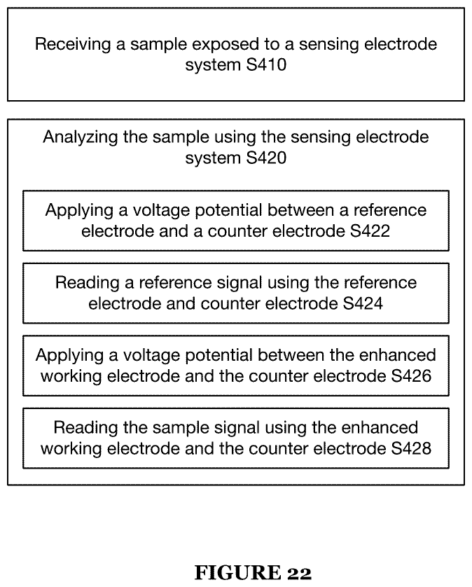

A method S400 for operating a sensing electrode system, as shown in FIG. 22, may include receiving a sample exposed to a sensing electrode system S410; and analyzing the sample using the sensing electrode system S420 which may include applying a voltage potential between a reference electrode and a counter electrode S422, reading a reference signal using the reference electrode and counter electrode S424, applying a voltage potential between the enhanced working electrode and the counter electrode S426, and reading the sample signal using the enhanced working electrode and the counter electrode S428.

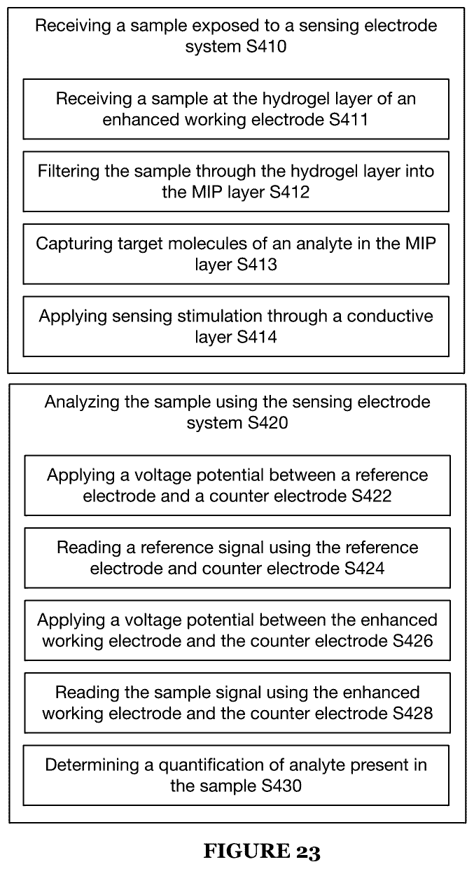

This method S400 preferably relies on handling and transformations of a sample enabled through an enhanced working electrode described herein. A sample is preferably supplied to the working electrode, and that sample interacts with the stack of the electrodes so as to filter undesirable particles/molecules and ideally create conditions where a targeted analyte is captured in defined cavities in a way that can be electrochemically measured. As such method S400 may additionally or alternatively include, as shown in FIG. 23, receiving a sample at the hydrogel layer of an enhanced working electrode S411, filtering the sample through the hydrogel layer into the MIP layer S412, capturing target molecules of an analyte in the MIP layer S413, and then applying sensing stimulation through a conductive layer S414, and determining a quantification of analyte present in the sample S430.

Filtering the sample through the hydrogel layer into the MIP layer S412 may include filtering through physically blocking diffusion of a sample through the hydrogel. This functions to block large particles, contaminates, and/or large molecules from moving into the MIP layer. Filtering the sample may additionally or alternatively include chemically filtering. This may include chemically filtering through reacting un-desired components of a sample with added molecules in the hydrogel to eliminate interferents.

Block S414 may be performed in connection with S426, and block 430 may be performed as part of or in connection with S428. Determining the quantification of the analyte present in the sample will generally be based on a detected impedance change, which results from an analyte being captured in cavities. In some variations, these processes of operating may include collecting response signals for at least redox mediators S160 and determining an analyte measurement based on analysis of response signals of the at least two redox mediators S161 as described herein.

### 4. EXAMPLES

Hereafter are described different examples of system and method variations. These examples are not intended to limit the systems and/or methods and their variations and does not include every variation and combination of variations of the systems and methods described herein.

Example 1.1: A system for an electrode used in electrochemical sensing may include: a conductive layer deposited on a substrate; a molecular imprinted polymer layer deposited on top of the conductive layer; a hydrogel guard layer deposited on top of the molecular imprinted polymer layer; and a redox mediator material integrated within the hydrogel guard layer.

Example 2.1: A system for an electrode used in electrochemical sensing of an analyte may include: a working electrode comprising: a sensing structure with a conductive layer deposited on a substrate and a molecular imprinted polymer (MIP) layer deposited on the conductive layer, and a membrane structure on the sensing structure, wherein the membrane structure is a multilayered membrane structure. The multilayered membrane structure may be adjacent or otherwise interface with the MIP layer of the sensing structure. Example 2.1 may be used in combination with example 1.1, 3.1, 4.1 and/or their variations or combinations.

Example: 3.1: A system for an electrode used in electrochemical sensing of an analyte may include: a working electrode comprising: a sensing structure with a conductive layer deposited on a substrate and a molecular imprinted polymer (MIP) layer deposited on the conductive layer, a membrane structure on the sensing structure, and a redox mediator material integrated into the membrane structure. Example 3.1 may be used in combination with example 1.1, 2.1, 4.1 and/or their variations or combinations.

Example 4.1: A system for measuring an analyte comprising: a working electrode comprising: a sensing structure with a conductive layer deposited on a substrate and a molecular imprinted polymer (MIP) layer deposited on the conductive layer, a membrane structure on the sensing structure, and at least two types of redox mediator materials. Example 4.1 may be used in combination with example 1.1, 2.1, 3.1 and/or their variations or combinations.

Example 1.2: A variation of example 1.1, 2.1, 3.1, 4.1 and/or any of the other system examples and variations herein, wherein the redox mediator material is selected from a group of redox mediator materials consisting of methylene blue, congo red, a ferricyanide and ferrocyanide, prussian blue, indophenol, diphenylamine, 2,6-Di-tert-butyl-p-cresol, 2,4-Dinitrophenylhydrazine, and tetrazolium salts.

Example 1.3: A variation of example 1.1, 2.1, 3.1, 4.1 and/or any of the other system examples and variations herein, wherein the conductive layer is a MXene conductive layer.

Example 1.4: A variation of example 1.3 wherein the MXene conductive layer is a MXene material of the form Mn+1XnTx, where M is selected from a group consisting of titanium (Ti), Vanadium (V), Chromium (Cr), Yttrium (Y), Zirconium (Zr), Niobium (Nb), Molybdenum (Mo), Hafnium (Hf), Tantalum (Ta), Tungsten (W), and where X is carbon or nitrogen, and Tis a functional group.

Example 1.5: A variation of example 1.1, 2.1, 3.1, 4.1 and/or any of the other system examples and variations herein, wherein the hydrogel guard layer is prepared with an ionic strength in a range of 35-235 millimolar.

Example 1.6: A variation of example 1.1, 2.1, 3.1, 4.1 and/or any of the other system examples and variations herein, wherein the conductive layer is a conductive ink printed onto the substrate.

Example 1.7: A variation of example 1.1, 2.1, 3.1, 4.1 and/or any of the other system examples and variations herein, the conductive layer comprises a MXene conductive layer adjacent to the substrate and a gold conductive layer between the MXene conductive layer and the molecular imprinted layer.

Example 1.8: A variation of example 1.1, 2.1, 3.1, 4.1 and/or any of the other system examples and variations herein, wherein the conductive layer is a material selected from a group consisting of a MXene material, a MXene carbon material, carbon black ink, graphene ink, silver ink, and gold ink.

Example 1.9: A variation of example 1.1, 2.1, 3.1, 4.1 and/or any of the other system examples and variations herein, wherein the MIP layer comprises defined cavities of a targeted molecule.

Example 1.10: A variation of example 1.9, wherein the targeted molecule is a cortisol molecule.

Example 1.11: A variation of example 1.9 wherein the targeted molecule is a molecule type selected from a group consisting of cortisol, Glutathione, Lactic Acid, estradiol, testosterone, Perfluorooctanesulfonic acid (PFOS), and per-and polyfluoroalkyl substances (PFAS).

Example 1.12: A variation of example 1.1, 2.1, 3.1, 4.1 and/or any of the other system examples and variations herein, wherein the molecular imprinted polymer layer is formed as spherical forms with defined cavities extending into the spherical form.

Example 1.13: A variation of example 1.1, 2.1, 3.1, 4.1 and/or any of the other system examples and variations herein, wherein the molecular imprinted polymer layer includes integrated nanoparticles.

Example 1.14: A variation of example 1.1, 2.1, 3.1, 4.1 and/or any of the other system examples and variations herein, further comprising an optical detector system directed to perform Raman spectroscopy through the molecular imprinted polymer layer.

Example 1.15: A variation of example 1.1, 2.1, 3.1, 4.1 and/or any of the other system examples and variations herein, wherein the substrate is a rigid substrate.

Example 1.16: A variation of example 1.1, 2.1, 3.1, 4.1 and/or any of the other system examples and variations herein, wherein the substrate is a flexible substrate.

Example 1.17 A system for electrochemical sensing of an analyte in a sample comprising: a sensing electrode system comprising: a working electrode that comprises: conductive layer deposited on a substrate, a molecular imprinted polymer layer deposited on top of the conductive layer, a hydrogel guard layer deposited on top of the molecular imprinted polymer layer, and a redox mediator material integrated within the hydrogel guard layer, a reference electrode, and a counter electrode; and a sample collector configured to direct a sample to the working electrode. The working electrode may be or include any of the working electrode variations described herein for examples 1.1, 2.1, 3.1, 4.1 and/or other system examples and variations.

Example 1.18: The system of example 1.17, wherein the conductive layer of the working electrode, the reference electrode, and the counter electrode are printed on a shared substrate surface.

Example 2.2: A variation of example 2.1, wherein the multilayered membrane structure comprises an external membrane layer and a concentrating membrane layer. The external membrane may have one externally exposed surface. The concentrating membrane layer may directly interface with the sensing structure. More specifically, the concentrating membrane layer directly interfaces with the MIP layer.

Example 2.3: A variation of example 2.2, wherein the external membrane layer and the concentrating membrane layers are configured with differing solubilities of the analyte.

Example 2.4: A variation of example 2.2, wherein the external membrane layer is a matrix structure with an added (or infused) solvent (i.e., external layer solvent).

Example 2.5: A variation of example 2.4, wherein the external membrane layer has a solubility less than the solvent. For example, the external layer solvent may be a water-based solvent.

Example 2.6: A variation of example 2.5, wherein the concentrating membrane layer has a matrix structure with an added (or infused) concentrating solvent where the analyte has a higher solubility with the concentrating solvent relative to the solubility of the analyte in the solvent of the external membrane layer.

Example 2.7: A variation of example 2.2, wherein the external layer is a hydrogel layer, and the concentrating membrane layer is an alcogel layer.

Example 2.8: A variation of example 2.2, wherein the external membrane layer is a paper filter layer. The paper filter may have a hydrophilic area. The hydrophilic area may have a shape profile to filter to a targeted sample area of the sensing structure (the adjacent layers below).

Example 2.9: A variation of example 2.2, wherein the external layer directly interfaces with the concentrating membrane layer.

Example 2.10: A variation of example 2.2, wherein the multilayered membrane structure comprises at least one intermediary layer between the external membrane layer and the concentrating membrane layer. In other words, the external membrane layer may interface indirectly with the concentrating layer through an intermediary layer. For example, the sensing electrode may include one or more filter layers as an intermediary layer (e.g., a lay between the concentrating membrane layer and the external membrane layer facilitating an indirect interface between the concentrating membrane layer and the external membrane layer).

Example 2.11: A variation of example 2.2, wherein the external membrane layer comprises microfluidic channels.

Example 2.12: A variation of example 2.1, further comprising a redox mediator material integrated into the membrane structure.

Example 2.14: A variation of example 2.1, wherein there are at least two types of redox mediator materials.

Example 3.2: A variation of example 3.1, wherein the membrane structure is a multilayered membrane structure

Example 3.3: A variation of example 3.2, wherein the redox mediator material is in one sublayer of the multilayered membrane structure.

Example 3.4: A variation of example 3.2, wherein the redox mediator material is in two or more sublayers of the multilayered membrane structure.

Example 3.5: A variation of example 3.1, wherein there are two or more types of redox mediator materials integrated into the membrane structure.

Example 4.2: A variation of example 4.1, wherein the at least two types of redox mediators comprise a first type of redox mediator and a second type of redox mediator with differing response signals.

Example 4.3: A variation of example 4.2, further comprising a sensor controller configured to use the different response signals to generate a measurement of the analyte.

Example 4.4: A variation of example 4.1, wherein the at least two types of redox mediator materials are integrated into the membrane structure.

Example 4.5: A variation of example 4.4, wherein the membrane structure is a multilayered membrane layer

Example 4.6: A variation of example 4.7, wherein the at least two types of redox mediator materials comprise a first type of redox mediator and a second type of redox mediator in a sublayer of the multilayered membrane layer. In such a variation, the membrane layer may include an external membrane layer and a concentrating membrane layer. In some variations, the at least two types of redox mediators are added or included in the concentrating membrane layer. In some variations, the at least two types of redox mediators are added or included in the external membrane layer. In some variations, the redox mediators may be added or included in an intermediary sublayer of the membrane structure. In some variations, one or more redox mediators may be included in two or more sublayers of a multilayered membrane structure.

Example 4.7: A variation of example 4.1, wherein the at least two types of redox mediator materials are integrated into the MIP layer.

Example 5.1: A method for an electrode used in electrochemical sensing may include: depositing or forming a conductive layer S110; depositing or forming a polymer layer S120 and creating imprinted molecular cavities in the molecular polymer layer forming a molecular imprinted polymer layer S130; and depositing a membrane structure S140.

Example 6.1: A method for producing a working electrode for measuring an analyte comprising: depositing or forming a conductive layer; depositing or forming a polymer layer and creating imprinted molecular cavities in the molecular polymer layer forming a molecular imprinted polymer layer; and depositing a membrane structure, which comprises depositing at least a first sublayer of the membrane structure and depositing at least a second sublayer of the membrane structure. Example 6.1 may be used in combination with example 5.1, 7.1, 8.1 and/or their variations or combinations.

Example 7.1: A method for producing a working electrode for measuring an analyte comprising: depositing or forming a conductive layer; depositing or forming a polymer layer and creating imprinted molecular cavities in the molecular polymer layer forming a molecular imprinted polymer layer; depositing a membrane structure; and depositing (or otherwise integrating) redox mediator material into the membrane structure. Example 7.1 may be used in combination with example 5.1, 6.1, 8.1 and/or their variations or combinations.

Example 8.1: A method for producing a working electrode for measuring an analyte comprising: depositing or forming a conductive layer; depositing or forming a polymer layer and creating imprinted molecular cavities in the molecular polymer layer forming a molecular imprinted polymer layer; depositing a membrane structure; and depositing (or otherwise integrating) multiple types of redox mediator materials into the enhanced electrode. Example 8.1 may be used in combination with example 5.1, 6.1, 7.1 and/or their variations or combinations.

Example 5.2: A variation of 5.1, 6.1, 7.1, 8.1, and/or any of the other method examples and variations herein, wherein Block S130 may more specifically include imprinting template molecules forming defined cavities of targeted molecules S132 and then removing the template molecules or otherwise emptying the defined cavities S134.

Example 8.2: A variation of 8.1, wherein depositing multiple types of redox mediator materials comprises, depositing two or more different types of redox mediators into the membrane structure.

Example 8.3: A variation of example 8.2, wherein depositing a membrane structure comprises depositing at least a first sublayer of the membrane structure and depositing at least a second sublayer of the membrane structure.

Example 8.4: A variation of example 8.1, wherein depositing multiple types of redox mediator materials comprises depositing two or more different types of redox mediators into the MIP layer.

Example 8.5: A variation of example 8.1, further comprising collecting response signals for at the multiple redox mediator materials and determining an analyte measurement based on analysis of response signals of the at least two redox mediators.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeably without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

1. A system for measuring an analyte comprising:
a working electrode comprising:
a sensing structure with a conductive layer deposited on a substrate and a molecular imprinted polymer (MIP) layer deposited on the conductive layer, and
a membrane structure on the sensing structure, wherein the membrane structure is a multilayered membrane structure.

2. The system of claim 1, wherein the multilayered membrane structure comprises an external membrane layer and a concentrating membrane layer.

3. The system of claim 2, wherein the external membrane layer and the concentrating membrane layers are configured with differing solubilities of the analyte.

4. The system of claim 2, wherein the external membrane layer is a matrix structure with an added solvent.

5. The system of claim 4, wherein the external membrane layer has a solubility less than the solvent.

6. The system of claim 5, wherein the concentrating membrane layer has a matrix structure with an added concentrating solvent where the analyte has a higher solubility with the concentrating solvent relative to the solubility of the analyte in the solvent of the external membrane layer.

7. The system of claim 2, wherein the external layer is a hydrogel layer, and the concentrating membrane layer is an alcogel layer.

8. The system of claim 2, wherein the external membrane layer is a paper filter layer.

9. The system of claim 2, wherein the external layer directly interfaces with the concentrating membrane layer.

10. The system of claim 2, wherein the multilayered membrane structure comprises at least one intermediary layer between the external membrane layer and the concentrating membrane layer.

11. The system of claim 2, wherein the external membrane layer comprises microfluidic channels.

12. The system of claim 1, further comprising a redox mediator material integrated into the membrane structure.

13. The system of claim 1, further comprising at least two types of redox mediator materials.

14. The system of claim 12, wherein the redox mediator material is selected from a group of redox mediator materials consisting of methylene blue, congo red, a ferricyanide and ferrocyanide, prussian blue, indophenol, diphenylamine, 2,6-Di-tert-butyl-p-cresol, 2,4-Dinitrophenylhydrazine, and tetrazolium salts.

15. The system of claim 1, wherein the conductive layer is a MXene conductive layer.

16. The system of claim 1, wherein the MIP layer comprises defined cavities of a targeted molecule.

17. The system of claim 1, further comprising: a sensing electrode system that comprises the working electrode, a reference electrode, and a counter electrode; and a sample collector configured to direct a sample to the working electrode.

18. A system for measuring an analyte comprising:
a working electrode comprising:
a sensing structure with a conductive layer deposited on a substrate and a molecular imprinted polymer (MIP) layer deposited on the conductive layer,
a membrane structure on the sensing structure, and
a redox mediator material integrated into the membrane structure.

19. The system of claim 18, wherein the membrane structure is a multilayered membrane structure.

20. The system of claim 19, wherein the redox mediator material is in one sublayer of the multilayered membrane structure.

21.-36. (canceled)
